(19) United States
(12) Patent Application Publication
(10) Pub. No.: US 2005/0063772 A1
(43) Pub. Date: Mar. 24, 2005

(54) Connection assembly apparatus and method

(76) Inventor: Roy Victor Bladen, Albany (NZ)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/804,573

(22) Filed: Mar. 18, 2004

(30) Foreign Application Priority Data
Mar. 20, 2003 (NZ) 524,863

(51) Int. Cl. F16D 1/00

(52) U.S. Cl. 403/348

(57) ABSTRACT

The invention focuses on method and apparatus for simply attaching various building elements to a surface (which may be finished) in a manner where the connection is preferably substantially hidden after attachment. Applications include the erection of enclosures and partitions in bathrooms, showers and wet areas. As many of the members are hollow and route services, preferred embodiments allow for the passage of, and/or connection to, services such as plumbing from within the surface to which the element is attached and to within the member itself. Certain methods and apparatuses comprise interacting cam and engaging portions allowing the element to be attached to the cam portion, once it has been secured in place, in a simple action, such as that typical of bayonet type connections.

### FIELD OF THE INVENTION

The present invention is generally directed to a connection assembly for coupling a building element to a surface, and more particularly, a connection assembly for coupling a building to a surface while permitting services to pass between the surface and the building element.

### BACKGROUND OF THE INVENTION

The illustrated embodiment of the present invention was developed to fulfill existing needs in the bathroom industry. More specifically, the illustrated embodiment of the present invention aids in fulfilling previously unsolved problems associated with the installation of shower enclosures and other partitioning (e.g., partitions and doors around showers, shower receptors (trays) baths and spas, etc.) and problems associated with the varying installation practices of different countries and regions.

For instance, the U.S. and European markets follow substantially different sets of trade practices for the installation of bathroom structures, such as shower receptors, in each of the markets. One particular difference is how the plumbing and waste outlets are routed to the shower receptor and enclosure in each of the markets. In Europe, the norm is for all plumbing and waste pipes to be installed above floor level. A removable access panel is usually provided which allows access to the underside of the receptor for the connection of services such as plumbing and drainage.

In contrast, the U.S. market generally routes plumbing and waste conduits within the floor itself, meaning that waste pipes, etc., are cast or positioned within the floor. The U.S. methodology reflects a preferred installation of a shallow shower receptor with the sill or front skirt directly on the floor, acknowledging a consumer desire for the step into the shower enclosure to be as low as possible. There is no access panel as is used in the European market. This alternate form of installation also results in significant differences in the type of waste traps and how the various plumbing is routed and connected. The shallow nature and limited access under the receptor makes it difficult for subsequent tradesmen to attend to the connection of plumbing elements (under the receptor or within recesses on its underside) once the receptor has been installed. This problem becomes apparent when considering the commonly practiced procedure for shower installation in the U.S. and a number of other countries.

A typical procedure for a U.S. installation follows the sequence delineated below:
(i) the builder roughs out the position of the receptor and installs the receptor;
(ii) the plumber connects the waste and terminates the supply plumbing (behind the wall);
(iii) the builder completes the shower installation, including installing wet-wall linings and sealants;
(iv) the tiler tiles the enclosure; and
(v) the plumber returns to complete all remaining plumbing (in front of the wall).

The initial installation of the receptor makes it difficult for subsequent tradespersons who may not be present at that time. With such a high involvement of different tradespersons it becomes difficult to ensure the cooperation necessary to provide for the timely and professional installation of shower enclosures. This also imposes limitations on what is achievable, particularly for design considerations affecting the routing and connection of associated plumbing within the installation.

The greater access associated with European design and practice eases the requirements for cooperation between the varying tradespersons. This practice is opposed to many other countries, such as the United States, where tradespersons tend to perform their specific tasks individually and somewhat independently. Accordingly, for the U.S., it is not unusual for the tradesperson installing the partitioning and attending to the final connection of plumbing to arrive on site at the stage where the wall finishing (for wall and corner showers) are in place, and the shower receptor or flooring (e.g., showers with tiled floors) are also substantially completed. Any plumbing at this stage is virtually restricted to provided holes in the wall rather than on the underside of the receptor or through the floor.

A difficulty which also presents itself to the tradesperson is how to erect fittings such as supporting columns, elements, and other fixtures without damaging or dismantling substantially finished surfaces. Attempting to fix vertical members to a floor has been a difficult task and usually results in a visible mechanical connection, or increasing reliance to be placed on overhead or wall connections. Furthermore, many mechanical attachment techniques make the basal routing of plumbing to such vertical members virtually impossible or impractical and for this reason the routing of plumbing to vertical elements (which may contain horizontally directed body sprays) is almost exclusively from overhead or wall outlets. Attempts to route plumbing under shallow shower receptors sitting on the floor also present difficulties as it is difficult to subsequently connect and redirect such plumbing to vertical elements which can duct the plumbing to where needed. Market preference is directed towards as shallow a tray as possible, so as to avoid a step up into the shower, and hence problems associated with routing plumbing hidden under a tray is becoming more of an issue.

There are thus a number of problems facing the industry. These problems include:
Providing a connection system for vertical elements and members which is substantially hidden or invisible after installation;
Providing a connection system which allows for the accurate positioning and placement of vertical or other elements, particularly for attachment to finished or partly finished surfaces;
Providing a connection system which readily allows for plumbing or other services to be routed to within, and connected to, the element or member;
Providing a connection system which allows for connection of the element or member in a quick and easy fashion;
Providing a connection system which affords some mechanical strength and resists disconnection;
Providing a connection system which allows the element or member to be connected to a variety of different surfaces and finishes including (but not restricted to) metal, porcelain (both solid ceramic and coated), plastic, laminate, composite, tile, cement, masonry, various types of wall partitioning, suitable bath tubs, shower receptors, etc.; and
Providing an easy to use system which allows for the basal routing of plumbing under structures such as shower receptors or base surrounds and to redirect this up into subsequently attached vertical elements.

Thus, there exists a need for a connection system which allows for the substantially trouble free installation of varying supporting elements and members associated with structures, some suitable examples being shower and bathroom structures, and which optionally may also include allowance for the connection and routing of plumbing or other services. There also exists a need for a connection system suitable for use on finished surfaces.

### SUMMARY OF THE INVENTION

Embodiments of the present invention include many aspects and variations. While initially developed to provide means for the simple after-installation of supports and pillars for shower, spa, and bath enclosures during building construction or renovation, and in a manner where the connection was hidden, the principles lend themselves to a variety of embodiments which can help accommodate a greater range of user choice during design, or modification of existing components to take advantage of the present invention. A consideration was also the ability to route services such as plumbing or electrical wiring into these pillars or supports when necessary, and thus aspects of the present invention consider the situations where such services may, or may not, be present. Variations of the invention will be described in more detail below, with a summary of some of the variations considered to be within the scope of the invention.

One embodiment of a quick connect assembly formed in accordance with the present invention is provided. The quick connect assembly may be used for connecting a building element to a surface. The quick connect assembly includes a first locking member coupled to one of a building element or a surface, the first locking member having a first passageway extending through the first locking member. The quick connect assembly further includes a second locking member coupled to the other of the building element or the surface, the second locking member having a second passageway extending through the second locking member. The first and second locking members have cooperative cam locking elements to reversibly couple the building element to the surface.

One embodiment of a quick connect assembly formed in accordance with the present invention is provided. The quick connect assembly may be used for connecting a building element to a surface while permitting services to pass between the surface and the building element through the quick connect assembly. The quick connect assembly includes an interference member coupled to the building element or the surface, the interference member having a protrusion. The quick connect assembly further includes a receiving member coupled to the other of the building element or the surface. The receiving member has an engagement member, wherein the interference member may be positioned in a first position such that the protrusion may be longitudinally moved past at least a portion of the receiving member. The interference member may also be positioned in a locked position in which the interference member has been rotated a predetermined angular displacement from the first position such that the protrusion engages the engagement member to interlock the building element to the surface.

One embodiment of a connection assembly formed in accordance with the present invention is provided. The connection assembly may be used for connecting a building element to a surface and providing for services to pass between the surface and the building element. The connection assembly includes a building element having a cavity and a surface for supporting the building element. The connection assembly further includes a quick connect assembly for coupling the building element to the surface, the quick connect assembly having a passageway passing through the quick connect assembly. The connection assembly additionally includes a conduit for transferring services between a location disposed below the surface and the building element, the conduit passing through the cavity and the passageway.

One embodiment of a connection assembly formed in accordance with the present invention is provided. The connection assembly may be used in connecting a building element to a surface and providing for services to be transferred between the building element and the surface. The connection assembly includes a cam engaging portion and a complementary engaging portion which interact with each other in a quick connect manner from an unlocked connection to a locked connection. One of the engaging portions is coupled to the surface, and the other engaging portion is positioned at an end of the building element to be attached to the surface. The engaging portions are configured to allow for services to pass therethrough.

One embodiment of an internally pre-plumbed pillar formed in accordance with the present invention is provided. The internally pre-plumbed pillar may be used for coupling to a surface and for passing service therebetween via a service conduit. The internally pre-plumbed pillar includes a body with a hollow interior for housing at least a portion of the service conduit, the body including at or near one end a terminated section of plumbing comprising an extendible length of pipe biased to retract within the body. The internally pre-plumbed pillar further includes an engaging portion disposed at or near the one end of the body, the engaging portion complementary to a separate engaging portion fixable to the surface. The engaging portions interact to securely connect the pillar to the surface, wherein both engaging portions include open sections allowing the service conduit to pass therethrough.

One embodiment of a connection assembly formed in accordance with the present invention is provided. The connection assembly may be used in attachment of a building element to a structure, the connection assembly allowing for passage of plumbing associated with the building element through the connection assembly. The connection assembly includes a cam portion able to be fixed to the structure to which the building element is to be attached. The connection assembly further includes a complementary portion which engages with the cam portion so as to restrict longitudinal separation of one from the other. The complementary portion is either formed into the building element or is fixable thereto. The complementary portion and the cam portion each contain an aperture for allowing passage of the plumbing associated with the building element therethrough.

One embodiment of a building element formed in accordance with the present invention is provided. The building element may be used for use in a connection assembly. The building element includes a hollow section disposed along at least part of a length of the building element. The building element further includes an extendible plumbing extension portion. The extendible plumbing extension includes a movable section of pipe which can be extended from a retracted position wherein a distal end of the movable section of pipe is substantially within the hollow section of the building element to an extended position wherein the distal end is substantially outside of the hollow section of the building element. The extendible plumbing extension also includes a plumbing connection coupled to the distal end, the plumbing connection adapted to allow connection of the plumbing connection to a complementary plumbing connection.

One embodiment of a method of coupling a building element to a surface performed in accordance with the present invention is provided. The method includes coupling on an attachment end of the building element a first engaging portion. The method further includes attaching on the surface a second engaging portion which is configured to engage the first engaging portion to reversibly couple the building element to the surface. The engaging portions are coupled to one another in a bayonet type manner. The method additionally includes installing a service conduit for passing a service between the building element from a point below the surface to a point within the building element. The service conduit passes through the first and second engaging portions such that the service conduit is hidden from view when the building element is coupled to the surface.

One embodiment of a method for attaching a building element forming part of a shower assembly and housing plumbing to a support surface performed in accordance with the present is provided. The method includes fixing a first engaging portion and a plumbing connection to the support surface. The method further includes connecting a complementary second engaging portion to one end of the building element. The method additionally includes installing plumbing within the building element with an end portion moveable outward from the building element to allow for connection of the plumbing to the plumbing connection fixed to the surface. The method further yet includes bringing the end of the building element into proximity with the first engaging portion and connecting the end portion of the plumbing to the plumbing connection. The method still further yet includes coupling the first and second engaging portions in a quick to connect manner to couple the building element to the surface.

One embodiment of a method performed in accordance with the present invention for attaching a building element of a shower assembly to a support surface, the building element housing plumbing, is provided. The method includes fixing a first engaging portion to the support surface and fixing a first plumbing connection to the support surface. The method further includes attaching a complementary second engaging portion capable of interlocking with the first engaging portion on the building element. The method additionally includes providing the plumbing within the building element with an end portion which is substantially rigid and fixing a second plumbing connection to the end portion. The method still further includes positioning the second engaging portion of the building element over the first engaging portion coupled to the support surface. The method also includes rotating the building element for interlocking the first engaging portion with the second engaging portion, wherein the positioning and rotating action also results in connection of the first and second plumbing connections to one another.

One embodiment of a method performed in accordance with the present invention of installing a shower enclosure which includes one or more building elements, wherein the building elements house plumbing associated with the enclosure, and wherein the building elements are coupled to a base structure, is provided. The method includes positioning and fixing to the base structure a cam portion for attaching the building element to the base structure. The method further includes bringing an end of the building element into proximity to the cam portion and connecting the plumbing housed within the building element to a plumbing connection associated with the base structure. The method additionally includes affixing the building element to the cam portion by engagement of a complementary engaging portion present at the end of the building element with the cam portion.

One embodiment formed in accordance with the present invention may be described as a connection system comprising engaging portions, one of which portions is associated with a member to be attached to a surface or structure, and the other portion attachable to said surface or structure (which may be during or post-construction depending on the embodiment), and which portions preferably interact and engage with a partial rotational (and preferably bayonet type) action.

In one embodiment formed in accordance with the present invention, the connection arrangement is substantially hidden, except by user choice, when the member is ultimately attached to the surface or structure by engagement of the portions. Preferably one portion can be considered a cam or cam-like arrangement which interacts with the second portion which can be likened to an annular sleeve. The components are preferably hollow or have removed portions to allow plumbing or services to pass from the surface (or structure) through to the building element being attached and which element may be pre-plumbed and/or pre-wired.

According to one aspect of one embodiment formed in accordance with the present invention, there is provided an interacting arrangement of components for the connection of a building element to a surface and providing for services to exit the surface and enter the attached building element, the interacting arrangement including:
a first cam-like engaging portion and a complementary annular-like engaging portion which interact with each other in a partial rotational connection arrangement;
one of the engaging portions being positionable at the attachment point on the surface, and the other positioned at the end of the building element to be attached to the surface;
the engaging portions being configured to allow for services to pass axially therethrough;
the arrangement defined such that when the building element is attached to the surface, any said services and the cam portion are substantially shielded from view from the exterior.

According to an additional aspect of the above-described embodiment, the partial rotational engagement is a bayonet type action as defined herein.

According to an alternate embodiment formed in accordance with the present invention, there is provided an internally pre-plumbed pillar for use in a shower or bath enclosure which is modified for attachment to a substantially finished surface, the pillar comprising:
a body with hollow interior housing said plumbing, and including at or near the end of attachment a terminated section of plumbing in turn comprising an extendible length of pipe or tube biased to retract to within the body;
there being provided at or near the end of the body an engaging portion complementary to a separate engaging portion fixable to said surface, and which interact to securely connect the pillar to the surface to which the separate engaging portion is fixed;
both engaging portions including removed sections allowing said plumbing to pass therethrough, and wherein one engaging portion substantially accommodates the other within when connected such that the plumbing and connection is substantially hidden from view when the pillar is attached to the surface.

According to another embodiment formed in accordance with the present invention, there is provided a method of attachment for a building element, said method including:
i) providing on the attachment end of the building element (as herein defined) a first engaging portion which is configured to engage, as a consequence of at least relative rotation, with
ii) a second engaging portion which is able to be affixed to the surface to which the building element is to be connected, with attachment being achieved in a partial rotational, and preferably bayonet type, manner including components of both linear translation of the first engaging portion relative to the second engaging portion, and rotation, and wherein one of the engaging portions includes a cam-like portion and the other engaging portion includes a complementary annular-like portion.

According to another aspect of the present invention, there is provided the method of attachment described above in which the cam portion comprises a disc-like portion with at least one engaging portion of which the building element interacts.

According to another aspect of the present invention, there is provided the method of attachment described above in which a said engaging portion of the building element comprises a sleeve or annular portion.

According to another aspect of the present invention, there is provided the method of attachment described above in which the cam portion includes a plumbing connection, or means for including a plumbing connection, to which a water supply pipe or the like can be connected.

According to another aspect of the present invention, there is provided the method of attachment described above in which the cam portion includes provision for allowing it to be affixed to a surface in a precise manner, allowing the building element to be precisely positioned in relation to the surface when attached.

According to another aspect of the present invention, there is provided the method of attachment described above wherein a surface comprises at least one of: a floor, a shower receptor, a bath tub, a partial wall structure, a wall, a surround, a horizontal support surface, an inclined support surface, and a vertical support surface.

According to another aspect of the present invention, there is provided the method of attachment described above in which the building element is in, after attachment to the cam portion, a substantially vertical, horizontal, or angled position, or possessing components of one or more thereof.

According to another aspect of the present invention, there is provided the method of attachment described above in which said building element houses plumbing, and where the plumbing within the building element is modified such that its end, closest to the end of the building element being attached, is either or both flexible and extendible so as to be able to be temporarily withdrawn from the end of the building element to allow attachment to a plumbing connection associated with the cam.

According to another aspect of the present invention, there is provided the method of attachment described above in which the cam portion includes one or both of an aperture, and removable portion providing an aperture, through which services may pass, said services including but not restricted to plumbing and electrical conduits or carriers.

According to another embodiment formed in accordance with the present invention, there is provided a method for attaching a building element (as herein defined), forming part of a shower assembly, to a support surface, said method including:
i) fixing a first engaging portion, such as a cam member to said support surface, and where said building element houses plumbing, including a plumbing connection into the cam fixture;
ii) providing a complementary second engaging portion, such as an annular connection portion on the end (to be connected) of the building element, said second engaging portion capable of engaging with the complementary portion in a partial rotational engagement, and preferably bayonet type, action and which restricts or prevents longitudinal movement of the hollow member when so engaged;
iii) modifying the internally housed plumbing within the building element to have an end portion which can be extended from within the housing to allow for connection, should the plumbing end portion not already be configured in this manner;
iv) bringing the end of the building element into proximity with the cam fixture and, if present, connecting internal plumbing to the plumbing connection;
v) sliding the annular connection portion and end of the building element over the cam fixture, and rotating so as to engage.

According to another embodiment formed in accordance with the present invention, there is provided a method for attaching a building element (as herein defined), forming part of a shower assembly, to a support surface, said method including:
i) fixing a first engaging portion, such as a cam member, to said support surface, and where said building element houses plumbing, including a plumbing connection connectable to a plumbing connection associated with the cam fixture;
ii) providing a complementary second engaging portion, such as an annular connection portion on the end (to be connected) of the building element, said second engaging portion capable of engaging with the complementary first engaging portion in a partial rotational engagement manner, and preferably bayonet type manner, and in a manner which restricts or prevents longitudinal movement of the hollow member when so engaged;
iii) modifying the internally housed plumbing within the building element to have an end portion which is substantially rigid and to be so terminated as to form part of a quick connect type arrangement;
vi) positioning the end portion and end of the building element over the affixed first engaging portion, and rotating so as to engage, the positioning action also resulting in connection of the terminated end plumbing portion within the building element to a suitably terminated plumbing portion associated with the affixed engaging portion.

According to a further aspect of the present invention, there is provided a method for attaching a building element (as herein defined), substantially as described above, in which the quick connect type arrangement includes at least one of a: commercially available quick connect system for pipe sections, a push-lock connector such as the “John Guest” type for receiving an end pipe section, a push-fit type connection arrangement for pipe sections, an O-ring type push-to-connect type arrangement, a male and female type push-connect arrangement, or less preferably an olive and nut type connection arrangement.

According to another aspect of the present invention, there is provided the method of attachment described above in which the cam portion includes a provision for allowing it to be affixed to a surface in a precise manner, such as regard with the angular orientation of the cam portion relative to the surface, allowing the building element to be precisely positioned in relation to the surface when attached.

According to another aspect of the present invention, there is provided the method of attachment described above in which the building element is in, after attachment to the cam portion, a substantially vertical, horizontal, or angled position, or possessing components of one or more thereof.

According to another aspect of the present invention, there is provided the method of attachment described above in which said building element houses plumbing, and where the plumbing within the building element is modified such that its end, closest to the end of the building element being attached, is either or both flexible and extendible so as to be able to be temporarily withdrawn from the end of the building element to allow attachment to a plumbing connection associated with the cam.

According to another aspect of the present invention, there is provided the method of attachment described above in which the building element is substantially a hollow member (as herein defined).

According to another embodiment formed in accordance with the present invention, there is provided a method of installation of a shower enclosure which includes one or more building elements which may either or both support other elements of the enclosure, and house plumbing associated with the enclosure, said method including:
i) positioning and fixing to the floor, threshold, or base structure, cam portions forming part of the attachment for the building element;
ii) subsequently, concurrently, and/or prior to step (i), attending to connection of any plumbing leading to the cam fixture, other than that housed within the associated building element;
iii) bringing the end of the building element into proximity to the cam fixture and, if present, connecting the free end of any plumbing housed within the building element; and
iv) affixing the building element to the cam fixture by engagement of an annular engaging portion present at the end of the building element.

According to another aspect of the present invention, there is provided the method of installation of a shower enclosure as described above in which the floor or base structure is substantially finished prior to the positioning and fixing of the cam portions.

According to another aspect of the present invention, there is provided the method of installation of a shower enclosure as described above in which a floor of a building forms a floor for the shower enclosure, the method including the positioning of waste pipes and plumbing in the floor and terminating same substantially at the floor level, and where the floor is substantially finished prior to installation of said building elements which are preceded by the positioning and fixing of the cam portions; and where plumbing is optionally routed, where appropriate, to or through the cam portions to be connectable to plumbing within the building elements.

According to another aspect of the present invention, there is provided the method of installation of a shower enclosure as described above in which plumbing supplied to said building elements, and the engagement means for the building element including the cam portion, are substantially hidden from view after the building element has been engaged.

According to a further aspect of the present invention, there is provided a connection assembly for use in the attachment of building elements, said assembly allowing provision for the connection of plumbing when present within said building elements, said assembly including a cam portion able to be fixed to an existing structure or surface to which the building element is to be attached; the assembly also including a complementary annular portion which engages with the cam portion so as to restrict longitudinal separation of one from the other; the arrangement being further characterized in that the annular portion is either formed into the building element or is fixable thereto.

According to another aspect of the present invention, there is provided the connection assembly described above in which the cam portion includes at least one of:
i) a plumbing connection for the connection of plumbing within the building element to allow its connection to at least one water supply pipe;
ii) an aperture allowing for plumbing, electrical, or other services to pass through;
iii) a removable portion allowing for options (i) or (ii) when required; and
iv) a mechanism for restricting rotation of the cam portion.

According to another aspect of the present invention, there is provided the connection assembly as described above in which complementary plumbing connections are provided on both the cam portion and plumbing associated with the building element, said connections comprising a quick connect type of arrangement.

According to another embodiment formed in accordance with the present invention, there is provided a building element (as herein defined) which is hollow along at least part of its length for use in a connection assembly, said building element including an extendible plumbing extension portion comprising a flexible and/or extendable section of pipe which can be drawn from within the interior of the building element and free of the end of the building element to allow connection to a plumbing fitting, said extendible plumbing extension portion being attached or attachable to other plumbing components associated with the building element.

According to another aspect of the present invention, there is provided the building element described above in which the extendible plumbing extension portion includes a retractable (to within the interior of the building element) section of pipe which is biased to retract to within the hollow section.

According to another aspect of the present invention, there is provided the building element described above in which connection for the extendible plumbing extension portion allows for at least partial rotation of the extendible plumbing extension portion relative to the plumbing fitting.

According to another aspect of the present invention, there is provided the building element described above in which the extendible plumbing extension portion includes a flexible coil of pipe, which may be of metal, non-metal, or part-metal construction.

According to another aspect of the present invention, there is provided the building element described above which includes one or more jets, nozzles, or connections therefor, coupled in fluid communication with the plumbing.

According to another aspect of the present invention, there is provided the building element described above which includes, or provides for the connection of at least one control device, a few suitable examples being a hand-held water delivery unit (such as a hand shower), a fixed head water delivery unit, plumbing to an overhead shower or other water delivery unit, and an electrical device, such as a switch.

According to another aspect of the present invention, there is provided the building element described above which is pre-plumbed.

According to another aspect of the present invention, there is provided the building element described above in which the engagement portion and the building element are configured such that the cam portion is substantially hidden within the interior of the hollow member after engagement.

According to a further aspect of the present invention, there is provided a cam portion for use in a connection assembly as described above, said cam portion comprising a disc-like portion, and wherein portions of the disc may be removed or absent, the disc-like portion able to interact with an engagement portion in such a manner that engagement may occur after the cam portion has been affixed to a surface.

According to another aspect of the present invention, there is provided the cam portion described above in which there is included fixing means, or provision for the use of separate fixing means, for affixing the cam portion to a surface.

According to another aspect of the present invention, there is provided the cam portion described above in which, when affixed, the disc-like portion is raised slightly above or clear of the surface to which the cam portion is attached.

According to another aspect of the present invention, there is provided the cam portion described above, the cam portion including raised elements to assist in the positioning of the hollow member.

According to another aspect of the present invention, there is provided the cam portion described above, in which the cam portion includes an attached or integrated pipe connection.

According to another aspect of the present invention, there is provided the cam portion described above which includes rotation resisting means which interacts with features on the engagement means associated with the building element to resist disengagement and/or rotation.

According to another aspect of the present invention, there is provided the cam portion described above in which the rotation resisting means comprises part of at least one of: a ratchet type arrangement, a full locking arrangement, or more preferably a detent arrangement.

One method performed in accordance with the present invention provides for the attachment of a member or element to a surface, and preferably in a manner where the means of attachment or fastening is substantially hidden. The method will typically also be suitable for use in applications where there is limited or no access to the interior or underside of the existing surface or structure to which the element or member is to be attached, such as when the surface has been finished. Preferably the method also allows for the option of fixing, casting, or integrating components associated with the method into the surface (or underlying structure) at the time of surface preparation or finishing, as well as providing embodiments which will allow for implementation of the method to an already finished or substantially finished surface or structure.

One method performed in accordance with the present invention includes a method for the attachment of a building element, which may be substantially hollow, to an existing surface. Typically such building elements may comprise a support element, with one preferred type of support element constituting a vertical supporting member for a shower or bath enclosure, and to which other panels may be attached. However, preferred embodiments also include the instance where substantially free standing elements are provided. Quite often these elements or members are substantially vertical in orientation though the present invention also includes instances where these may be inclined (with respect to the vertical), or horizontal.

Embodiments of the present invention preferably utilizes interacting ‘cam’ and ‘annular’ engaging portions to effect a connection. In preferred embodiments, the annular portion is associated with the building element while the cam portion is associated with the surface structure at the point of attachment (of the building element). It is, however, envisioned that this association can be reversed such that the cam portion could be associated with the element, and the annular engaging portion with the surface or structure. The same principles of interaction and general design as discussed within this specification are applicable. It is considered that the skilled tradesperson, when armed with the description herein, will be able to implement such reversed embodiments of the invention from the description of the preferred embodiments. Accordingly, for simplicity and to avoid confusion, the remainder of the specification will largely refer to orientation of the preferred embodiments.

Preferred embodiments of the invention make use of a cam portion which, in the normal method of performing the method of the invention, is attached to the surface to which the building element is to be attached. The method of fixing is typically by either or both mechanical and adhesive fastening. Mechanical fastening methods include screwing, bolting, and various equivalents and alternatives thereof. A variety of suitable construction adhesives are known and these may used instead of, or in conjunction with, other mechanical fastening means. As a further variation, the cam portion may be formed, integrated, or cast into the surface at the time of its construction. For instance, a modified cam portion may be used which is positioned into cast concrete flooring. This may include a suitable anchor portion which is embedded in the concrete. It may also include distancing means so that the engaging portion of the cam is positioned above the floor surface. This may also take into account any floor finishing, such as tiles, which may be subsequently laid or put into place before attachment of the hollow member or element.

The cam portion will typically, in addition to means for fastening to the surface, include an engagement portion which can be disc-like in configuration, or include a central body portion with outwardly extending features or projections. This disc or body portion may also include removed portions which extend to or from the periphery of the disc or body. Apertures may also be provided within the disc or body, though this will be discussed later with reference to allowing services to pass through the cam portion. In other variations, multiple disc-like or repeating body portions may be provided and these may also have similar or dissimilar configurations. It is envisioned that the provision of two or more axially displaced co-axial disc-like or repeating body portions can improve the strength of the resulting attachment of the building element to the surface, though such an arrangement will typically also increase fabrication costs.

Preferably the disc-like (or alternate configurations) of the engagement portion will be positioned away from the surface to allow engagement with the attachment end of the building element to occur. Such spacing may be provided in a number of manners, including the provision of one or more stem portions, spacers, and/or body features. Whether services are to pass through the cam portion will also influence the specific body design.

In summary, most cam portions according to preferred embodiments of the present invention will include an engagement portion, which is preferably disc-like in appearance (though may have removed portions), an affixment portion allowing it to be affixed to the surface, and a spacing portion which distances the engagement portion from the surface. Other features may be provided including positioning pins, features, or faceted indentations to allow for the more ready alignment and/or positioning of the cam portion with respect to the surface. This becomes particularly important for cam portions used for the attachment of pillars which may have features present for the attachment of glass panels or doors. In this case, accurate alignment of the cam portion (which will also influence the rotational alignment of the attached member) is as important as the correct positioning of the cam portion on the surface.

It should be appreciated that the cam portion may comprise a single piece, or be constructed of separate components. The cam portion may be made of a number of materials including suitable plastics, metals, and composites which typically have properties of stiffness and rigidity, as well as strength commensurate to the task. Resilience is not normally a requirement except where this forms part of or contributes to the prevention of or resistance to rotation of the attached element with respect to the cam portion, or to resisting its removal therefrom. A certain amount of resilience in some components can also allow for greater tolerances in manufacturing, with deformation by component resilience compensating for too tight a tolerance. However the preference is for accurate and precise manufacturing.

An engaging portion is provided to interact with the cam portion. This may be a separate element or elements attached to the building element to be subsequently connected, or alternatively formed into the building element during its fabrication. When separately attachable engaging portions are provided, adaptors may be provided to allow its attachment to a hollow end portion of building elements of different internal configurations. This will increase the versatility of the present invention, and thus allow a single cam and insert (engaging portion) set to be used on a variety of differently configured hollow member building elements. Any means of attaching the engaging portion to the building element (including mechanical fastening, adhesive fastening and/or mechanical interaction between parts) should ideally be hidden from exterior view.

In the context of the present invention, the building element (to be attached) may only be hollow in the vicinity of where engagement with the cam portion occurs. In this case the remainder of the member may be solid or filled. However, for the types of applications provided herein, provision needs (in most cases) to be made for services such as plumbing, electrical wiring, etc., to pass through the attachment arrangement and also the building element to be attached. This will be discussed in more detail later.

Typically the engaging portion (associated with the building element) will substantially encircle the cam portion when fitting and attachment occurs. Accordingly the engaging portion may be sleeve like, with the sleeve often being represented by the interior wall of an insert, or the interior wall of a hollow member building element itself. Typically inwardly directed features are provided on the inward face of the engaging portion to interact with removed portions in the engaging portion of the cam.

For most embodiments of the present invention, the preferred method of attachment results from a partial rotational, and preferably bayonet type, action between the engaging portion and cam portion. More specifically, this represents axial sliding of the engaging portion over the cam portion, followed by subsequent partial rotation. After rotation, features on the engaging portion and/or cam portion interact (usually overlap) to prevent the two portions from becoming axially separated. If removal is allowed, then a reversal of the bayonet type fitting action will be required. In preferred embodiments however, rotation resisting features may be provided to prevent or resist one or more of these actions. A variety of rotation resisting mechanisms are known in the trade, including detent, ratchet, and similar mechanisms. One or more of these may be employed (for instance) to help lock the engaged component, or to resist release and separation.

When multiple disc-like or repeating body portions are provided on the cam portion, it is possible that the partial rotational action may be provided in respect of all the disc-like or repeating body portions. However, it is also possible that some of the disc-like and repeating body portions may not necessarily so engage. Instead they may merely serve to increase the relative strength of the attachment, so as to resist pivoting of the building element about the cam portion by increased surface contact between the components (at different points along the length of the member).

Accordingly, in preferred embodiments of the present invention, there is provided a cam portion which is fixable to a surface, and an engaging portion which may be inserted or formed into a building element. The two portions may be engaged through, preferably, a bayonet type action which involves relative sliding and rotation of the member (and associated engaging portion) over the cam portion. Providing that the engaging portion is suitably positioned within the interior of the building element to be attached, the result is an attached member with virtually no, or substantially no, visible evidence of the connection arrangement except by user choice.

Modifications may also be made to the arrangements of the invention such as by the provision of seals to help seal the base of the building element against the ingress of water or foreign material. These seals may be substantially invisible, or intended to be visible, in the attached assembly. These may be separate annular type members which are positioned over the cam portion (like a washer) prior to the attachment of the building element. Alternatively these may also form part of the cam portion.

Other cam portions may be configured so that the building element to be attached will, instead of being substantially perpendicular to the surface to which the cam portion is attached, be aligned at a predetermined angle to the perpendicular. This increases the versatility of the system, and the manner by which it may be used. These variations are also likely to find more use for the attachment of the building element to walls, and vertical and inclined surfaces other than just floors. An adjustable unit in which the resulting angle can be adjusted by movement and subsequent locking or tightening of the component is within the spirit and scope of the present invention.

It is envisaged for most applications that plumbing or other services will need to be routed to a wall or floor structure (to which the cam portion is to be attached) and to the building element. In this case, the building element is typically substantially hollow along its length to allow the provision of internal plumbing and services. The problem which is then introduced is how to allow for these services (or plumbing) to pass through the attachment arrangement, and also how suitable connections (for the plumbing or type of services) can be made in situ at the time of attaching the building element. Ideally this attachment should not interfere with the substantially hidden nature of the arrangement once the building element is attached. Further, the method of attachment of the services and plumbing should not interfere with the attachment mechanism and be able to cope with a bayonet type attachment operation. Most preferably, the arrangement should also be able to cope with situations where the building element may be pre-wired, or pre-plumbed, etc. However, not all embodiments of the present invention take into account this option. Some variations of the present invention which deal with these issues will now be discussed.

Embodiments of the present invention are adaptable to allow services to pass from an existing structure (or below a surface) to within the building element to be attached. While this could be accomplished in a number of ways, the preferred arrangement is to provide an aperture or removable portion allowing various services (including plumbing) to pass through the cam portion. This may be accomplished by the provision of one or more apertures in the engagement portion and any appropriate portions of the cam portion. Slots and removed portions are also possible. Removable ‘knock-out’ portions may also be provided so that the apertures are only present when required.

In a preferred embodiment there is a substantially centrally positioned aperture through which plumbing from the existing structure/surface can penetrate. This should be of sufficient dimension to allow the appropriate plumbing and/or other services to pass through. In practice, for plumbing, a cut off section of the pipe may protrude from the surface to which the building element is to be attached. The cam portion can then be positioned over this cut off portion of pipe. Ideally the aperture and/or other removed portion of the cam should be larger than the outside diameter of the pipe. This will allow some provision for movement of the cam portion with respect to the pipe so that the cam portion can be precisely positioned and located, even if the pipe is not. Typically at the next stages the pipe will be terminated with an appropriate fitting or modification made to allow the plumbing from within the member to be connected. It is also possible that the suitable terminating connector can be integrated into the cam portion so that other plumbing from the member may be directly connected to the cam portion itself. However, not all types of plumbing, plumbing connection systems, and situations may allow this particular variation. It is envisioned that more often than not (currently) a separate connector piece will be attached to the free end of the cut off pipe section.

Typically next, the connecting end of the building element will be brought into proximity to the cam portion which by now should have been secured to the surface. Taking the case of a pre-plumbed element, it is desirable that the internal plumbing can be extended free of the end of the building element so that connection can be made with the terminated plumbing associated with the cam portion. This is especially true for connection systems which may require a tool such as a spanner to complete the connection. However, there are also quick-to-connect and push-fit connection systems available which may be employed with the present invention. Providing suitable guidance, for alignment of the various components, is provided such that it is possible that adequate connection of plumbing sections can be completed by merely pushing the building element over the cam portion in order to complete the bayonet fastening arrangement. In such cases it will not be necessary to pull the internal plumbing section free of the end of the building element. However it is generally desirable that some visual confirmation of a secure connection can be made and thus it is envisioned that this would not normally be a preferred embodiment except where visible inspection and/or adjustment can be made through the wall of the building element itself. This is not a desirable arrangement as it complicates the fabrication process for the member, and also disturbs the aesthetics and smooth finish of most elements used in bathroom structures.

In one embodiment formed in accordance with the present invention, the plumbing is free to extend beyond the connecting end of a pre-plumbed building element. The modification is preferably made to facilitate such extension but to also allow withdrawal back into the building element once the connection (of the plumbing) is completed and the element is attached to the cam portion. This can be achieved by providing a coiled and extendable section of plumbing which can be pulled free from the connecting end of the building element to allow attachment to the pipe section associated with the cam portion. This extending section of plumbing is preferably of a resilient plastic material, though it may be metal, and ideally have a natural bias such that the coils are in close proximity or touching each other when in a rest state. Examples of such plastics are coiled air-line hoses used in spray painting and with air driven tools. These can be suitably modified and may be appropriate (e.g., using the appropriate materials to convey hot, cold, or mixed/tempered water) for use with plumbing code compliance and standards.

Various types of connection systems including various types of quick-to-connect systems, though more conventional threaded systems can still be employed when using extendable pipe embodiments of the present invention.

Also included within the present invention are modified building elements such as previously described and/or for use in conjunction with cam portions such as described herein. These include hollow members which are hollow primarily at or near the connection point to the cam portion only to fully tubular structures. Both closed and open structures are envisioned, with open structures including tubular members with removed portions which may extend along only part or all of the length of the member.

It is also envisioned that the building elements need not be straight and long and may also include curved and variously configured arrangements, including pre-assembled structures.

Building elements intended to house one or more elements, one suitable example being a building element housing plumbing and services, and those which house nothing, may be used and are included within the scope of the present invention. Those which carry services may be pre-plumbed, or pre-wired, etc. Various types of connection systems may be used for services other than plumbing. The same principles as described above for plumbing may be used though with connection systems for other types of services. It is envisioned that most other services than plumbing will be of an electrical nature and will tend to (in a bathroom situation) constitute power sources, or control signal sources for associated equipment such as thermostats, flow control, heating devices, sensors, manual or electronic control switches, etc.

Construction of a bathroom structure such as a shower enclosure can proceed, when aspects of the present invention are employed, in a number of manners. It is envisioned that embodiments of the present invention can cater to the various types of installation procedures adopted and performed throughout the world, as the system does not require access to the interior or underside of the surface itself providing the various services clear the surface or are otherwise accessible for connection. Accordingly, embodiments formed in accordance with the present invention are suitable for retrofitting as well as being integrated at an earlier stage of construction. It is also envisioned that the majority of embodiments allow for connection substantially without tools, or minimum tools, which simplifies the secure attachment of members to cam portions which have already been fastened to the surface. If the cam portions are, in case of a shower enclosure, installed at the factory (i.e., pre-plumbed) then the time taken by the plumber to install such plumbing is substantially eliminated, and the subsequent erection of the members is simplified. This makes it very easy for subsequent trades people, or the resident, to subsequently install various building elements and/or structures. It is envisioned that embodiments of the present invention may also be used for mounting other articles within the house, and particularly where provision for the introduction of services must be made at the attachment point.

It is also envisaged that the cam portion may be modified to interact with shower receptors, bathtubs, and bases for other structures, etc. These receptors and components may be fabricated to include suitable mounting points for a cam portion according to the present invention. These may also include locating lugs, facets, or recesses which complement lugs, facets, and recesses which may be provided on the cam portion. This can help the secure and precise placement of the cam portions, as well as ensuring their correct orientation—particularly when other components (such as shower doors and panels) are to be fitted at precise orientations to the member attached to the cam portions.

A preferred embodiment of the present invention ideally realizes one or more of the features listed below. Various embodiments may realize different combinations or other features than those listed following:
1. The engaging portion referred to as a cam is preferably attached, connected, or integrated with the supporting surface (e.g., floor, wall, shower receptor, bath tub, etc.);
2. The engaging portion referred to as the cam preferably has more than one flange portion which at least engages complementary features on the other engaging portion;
3. The engaging portions interact with a bayonet type interaction;
4. The rotation for engagement is preferably less than 360°;
5. There is preferably resistance to rotation or disengagement once the engaging portions have been coupled;
6. The engaging portions have a provision for the passage of plumbing and services therethrough;
7. Once the engaging portion referred to as the cam has been fastened or otherwise affixed to the supporting surface, preferably hidden plumbing and services are accessible from the exposed face(s) of the cam engaging portion;
8. In pre-plumbed building elements, preferably the connecting of plumbing is through a pull down section or plumbing or services which can be extended from the building element for connection to plumbing or services associated with the alternate (affixed) engaging portion to be made;
9. The pull down section of plumbing or services is preferably biased to retract to within the building element;
10. The connection of the engaging portions is substantially hidden from view in the connected arrangement;
11. The arrangement preferably allows for both accurate vertical and horizontal positioning of the building element, and stability of connection with respect to movement in the vertical and horizontal directions, and preferably also against pivoting from the vertical about the connection point; and
12. The engaging portion referred to as the cam portion is preferably a separate component (or assembly), though it may also be designed to be an integral component of the supporting surface.

### BRIEF DESCRIPTION OF THE DRAWINGS

The foregoing aspects and many of the attendant advantages of this invention will become better understood by reference to the following detailed description, when taken in conjunction with the accompanying drawings, wherein:

FIG. 1 is a partially exploded, partial cross-sectioned view of one embodiment of a connection assembly formed in accordance with the present invention showing the connection of an embodiment of a pre-plumbed hollow member to an existing surface;

FIG. 2 is an assembled view of the embodiment depicted in FIG. 1;

FIG. 3 is a partially exploded, partial cross-sectioned view of an alternate embodiment of a connection assembly formed in accordance with the present invention showing the connection of an embodiment of a pre-plumbed hollow member to an existing surface.

FIG. 4 is a partial cross-sectional side view of an alternative embodiment of a connection assembly formed in accordance with the present invention depicting a cam portion interacting with an engaging portion insert disposed on the inside of an embodiment of a building element;

FIG. 5 is a partial perspective view of a set of flanges disposed on the cam portion interacting with a set of flanges disposed on the engaging portion insert of the embodiment depicted in FIG. 4;

FIG. 6 is a partial side cross-section view of an alternative embodiment of a cam portion formed in accordance with the present invention;

FIG. 7 is an exploded perspective view of one embodiment of a connection assembly formed in accordance with the present invention;

FIG. 8 is a perspective view of a bottom side of the cam portion depicted in FIG. 7;

FIG. 9 is an elevation view of one embodiment of a capping piece formed in accordance with the present invention, the capping piece including a cam portion;

FIG. 10 is an alternative embodiment of a capping piece formed in accordance with the present invention having a separable cam portion shown in cross-section;

FIG. 11 is an elevation view of one embodiment of an interlocking member formed in accordance with the present invention for joining hollow members, the interlocking member fashioned from a plurality of cam portions, the cam portions shown in cross-section;

FIG. 12 is an elevation view of one embodiment of a cam portion formed in accordance with the present invention used for connecting hollow members at a predetermined angle from a surface; and

FIGS. 13A-C illustrate the preferred types of bayonet coupling action performed according to the present invention.

### DETAILED DESCRIPTION OF THE PREFERRED EMBODIMENT

Although embodiments of the present invention are described as implemented with regard to shower systems, one skilled in the relevant arts will appreciate that the disclosed connection assembly and the disclosed embodiments are illustrative in nature and should not be construed as limited to application with regard to shower systems. It should therefore be apparent that the connection assembly has wide application, and may be used in any situation where connecting two objects together while permitting services to pass therethrough is desired.

A number of terms will be referenced within this specification. It is known that different countries adopt different terminology for common items. This is particularly true in the building and construction trade, and for this reason the following glossary is given to more precisely define the intentions of the applicant with regard to these terms.

### GLOSSARY OF TERMS USED

The following definitions are provided for certain terms and phrases used in this application. These definitions are provided solely for convenience, and should not be construed to provide a meaning having a scope less than would be understood by a person of ordinary skill in the art.
cam portion: an element having features which can interact to engage with a complementary engaging portion in such a way as to impede the longitudinal movement of the cam portion in relation to the complementary engaging portion.
cam fixture: the cam portion when fixed to a surface or structure.
building element: an element which one wishes to attach to a structure or surface. The building element may include of more than one component and therefore can include an assembly of components. The element may be hollow. For many applications the building element may be a post or like component for use in a shower cubicle or partition. It may sometimes be a horizontal member such as a rail or part of an overhead support structure. The building element may also have various associated components and services pre-installed or pre-assembled thereto.
hollow member: an element which has a cavity or channel for optionally housing services, such as plumbing, wiring, etc. Hollow members may form part of bathroom (or like) structures such as bath, spa and shower enclosures. These may be of varying cross-sections (i.e. their shape may not be constant along their length), and may have circular, oval, “D”, “C”, “U”, or other shaped cross-sections. The cavity or channel may extend only partly or substantially fully along the length of the hollow member. The member may be a closed hollow member (where only access to the cavity is via the ends) or an open hollow member where the cavity may be accessible at other points along the length of the hollow member. More specifically, open hollow members may not be completely closed along their whole length and may have “C”, “U”, “V”, or other shaped cross-sections. The open hollow members may interact with other walls or elements to further close the cavity once installed. As mentioned above, the cavity may also be present only along part of the length of the member, the member being solid or filled at other points. Preferably, the hollow portion is present at least one end where connection to the cam portion is to be made.
plumbing: an enclosed structure for conveying a fluid. Plumbing may include pipes and conduits for carrying water, air, waste, or other fluids, such as pipes for conveying water to be supplied to jets, nozzles, faucets, shower roses, etc.
plumbing connector: a device for coupling plumbing in fluid communication with another device. A plumbing connector may include elbows and junctions. Many different types of plumbing connectors are within the spirit and scope of the above definition, including push-fit and quick-connect type devices, such as John Guest push-fit connectors. Preferably the plumbing connectors allow for at least partial rotation of the plumbing connector after connection, permitting rotation of the cam portion and its complementary engaging portion during installation of the building element to the surface.
engage by partial rotation: engagement in which there is included, as part of the action required, a rotational action. By partial is meant that rotation is only part of the relative movement of the engaging portions when they are brought together and set to an engaged position. A preferred example of partial rotational engagement is the bayonet type action defined below. Preferably the relative rotation is less than 360°.
bayonet type action: in a bayonet type action there is both linear and rotational components in the relative movement of the engaging members when they are brought into proximity and set into an engaged position that resists at least longitudinal or linear withdrawal. There are three preferred forms of bayonet type action suitable for use with an embodiment formed in accordance with the present invention. The first is a ‘flat bayonet action’ where overlapping components of the engaging components only start to overlap with each other when rotation occurs after linear positioning. The second is the typical ‘light bulb type’ bayonet action where a guide element substantially prevents or limits relative rotation until linear positioning is completed. The third type is a ‘helical bayonet action’ in which rotation introduces a linear component to the relative movement of the engaging portions—such as drawing one portion down into the other. Reference is made to drawings later herein depicting the three preferred forms of bayonet type action.
translational movement: a linear or sliding movement, as opposed to a rotational movement. The bayonet action can be described as action having both translational movement and rotation movement components.
at the end: in proximity to an end of an object. Typically this term is used in relation to the annular attachment portion disposed ‘at the end’ of the hollow member or building element. In this context, ‘at the end’ means provided in a manner allowing the hollow member to be connected at its end to a surface or other object. The annular attachment portion may therefore be fixed or formed on the end of the hollow member (and thus be visible from outside) or housed internally within the member such that it is not externally visible. Hence ‘at the end’ should be read to mean ‘at or near the end’.
annular attachment portion: is an element or assembly which is preferably annular or ring like in overall appearance, but need not necessarily be so. The term annular is used to functionally describe the fact that this portion engages about the cam portion. Sleeves and hollow cylinders fall within the definition. An annular attachment is a subset of the term ‘engaging portion’.
Whirlpool: in some countries being a generic term which includes jetted baths with an associated pump for air and/or water, and in some countries referred to as a spa. The terms ‘whirlpool’ and ‘spa’ will be taken to be equivalent when used herein.

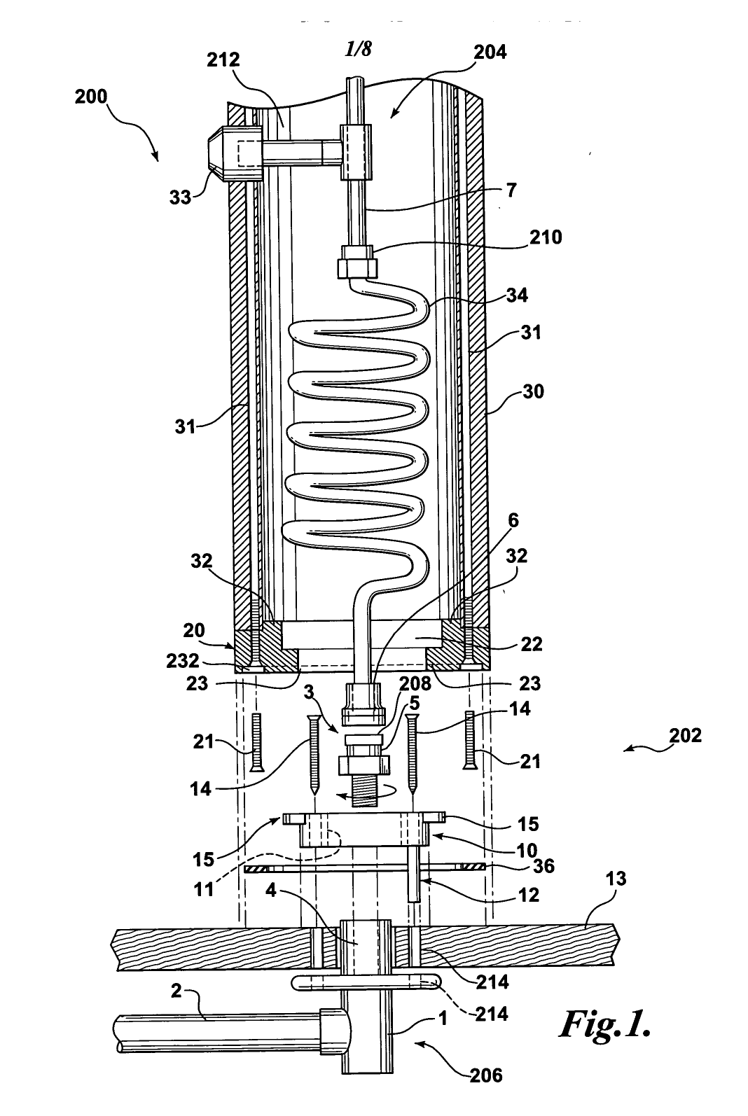

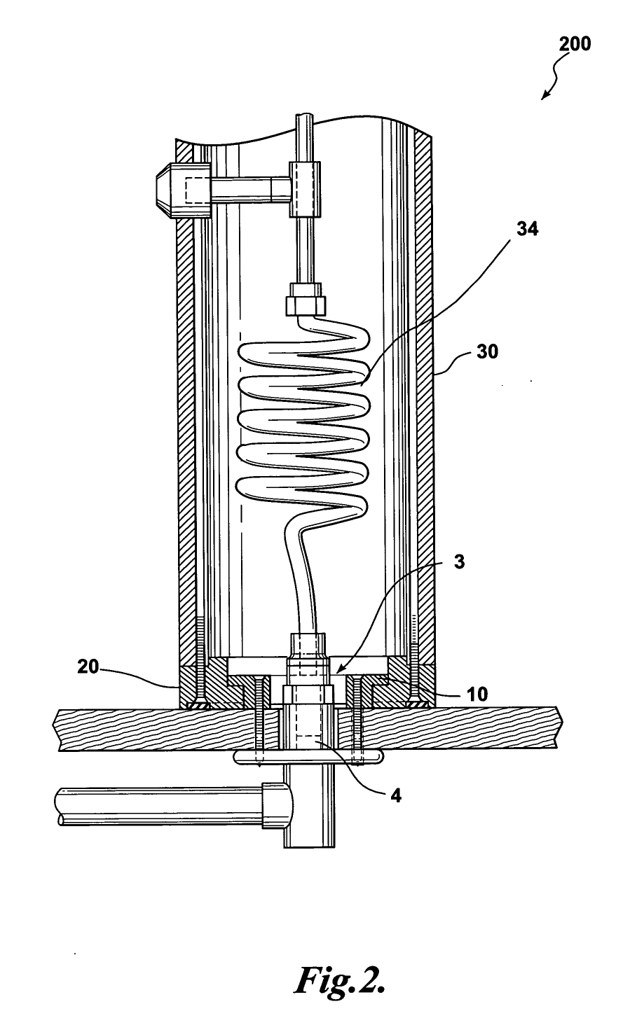

FIGS. 1 and 2 illustrate one embodiment of a shower assembly 200 formed in accordance with the present invention. Generally stated, the shower assembly 200 includes plumbing 204 and 206 for transferring shower water from a water source (not shown) to a nozzle 33, wherein the plumbing 204 and 206 is hidden from view below a surface 13 and within a building element 30, to which the nozzle 33 is attached. The shower assembly 200 includes a connection assembly 202 which permits the coupling of the building element 30 to the surface 13 in a quick connect manner while permitting the plumbing 204 and 206 to pass hidden from view between the surface 13 and the building element 30 through the connection assembly 202.

Focusing on the plumbing 204 and 206, the plumbing 204 and 206 may be subdivided into an upper portion 204 associated with the building element 30 and a lower portion 206 associated with the surface 13. The lower portion includes a supply pipe 2 terminated in a plumbing fitting 1. The plumbing fitting 1 is a standard flanged terminating elbow as is commonly used within wall cavities and other structures for supplying water to subsequently attached fittings. Cooperating with the plumbing fitting 1 is a threaded adapter 3 which threads into a threaded female portion 4 of the plumbing fitting 1. Disposed at the top end 5 of the threaded adapter 3 is an appropriate fitting 208 for connecting to a connector 6 of the upper portion 204 of the plumbing. Preferably the threaded adapter 3 couples to the connector 6 of the upper portion 204 of the plumbing in a quick-to-connect arrangement, one suitable example being what is known in the trade as a JOHN GUEST fitting. The threaded adapter 3 is generally fitted to the plumbing fitting 1 prior to installation of the other components.

Although specific fittings are described and illustrated for coupling the upper portion 204 and the lower portion 206 of plumbing in fluid communication with one another, it should be apparent to those skilled in the art that any number of coupling systems may be utilized for coupling the upper and lower portions 204 and 206 to one another and are therefore within the spirit and scope of the present invention. A few suitable examples of alternate coupling methods include coupling a connector 6 upon the upper section that is adapted to rotate upon the distal end of the upper portion 204 such that a set of external threads of the connector 6 may directly engage the internally threaded female portion 4 of the plumbing fitting 1, thereby eliminating the need for the adapter 3. Further, the upper and lower portions 204 and 206 may be a continues unbroken section of piping, passing between the surface 13 and the building element 30 without the need of connectors.

The upper portion 204 of the plumbing will now be discussed in greater detail. The upper portion 204 of the plumbing includes a flexible section 34 of pipe and a rigid section of pipe 7 coupled to one another via a plumbing connection 210. Coupled to a distal end of the flexible section 34 of pipe is the connector 6 for coupling to the threaded adapter 3 as described above. The flexible section 34 of pipe is selectively extendable, expandable, and/or adjustable in overall length such that the connector 6 may be moved longitudinally relative to the building element 30. Preferably, the flexible section 34 is adjustable in length such that the connector 6 may be moved longitudinally into an extended position wherein the connector 6 is at least partially disposed outward of the building element 30, as shown in FIG. 1. In the extended position, the connector 6 may be accessed by the user to couple the connector 6 to the threaded adapter 3 prior to the coupling of the building element 30 to the surface 13 via the connection assembly 202.

Preferably, the flexible section 34 is biased to pull the connector 6 from the extended position to a retracted position, wherein the connector 6 is at least partially disposed within the building element 30 as shown in FIG. 2. Thus, when the building element 30 is coupled to the surface 13, the connector 6 and flexible section 34 are automatically withdrawn into the building element 30. This ensures that the connector 6 and flexible section 34 are out of the way of the building element 30 and the surface 13, and therefore do not interfere during the coupling of the building element 30 to the surface 13. In the illustrated embodiment, the flexible section 34 is a flexible coil of plastic tubing, however it should be apparent to those skilled in the art that other types of sections of piping adapted to extend in length are within the spirit and scope of the present invention, one suitable example being a telescoping section of pipe.

The rigid section of pipe 7 is affixed to the building element 30, and therefore does not move relative to the building element 30. The rigid section of pipe 7 passes through a central cavity 212 of the building element 30, delivering water to at least one control device, some suitable examples of control devices being fixed or handheld roses, mixing valves, faucets, and spray nozzles 33, which are plumbed within the building element 30.

This detailed discussion will now focus upon the connection assembly 202. The connection assembly 202 generally includes a locking member, a receiving member, or a cam portion 10 which interlocks with a locking member, an interference member, or an engaging portion 20. The cam portion 10 in the illustrated embodiment is coupled to the surface 13 and the engaging portion 20 is coupled to the building element 30. The cam portion 10 may be selectively engaged with the engaging portion 20 to couple the building element 30 to the surface 13 in such a manner as to at least resist the longitudinal movement of the building element 30 relative to the surface 13, i.e., to resist their separation.

Still referring to FIGS. 1 and 2, the cam portion 10 includes a passageway, open center, or substantially hollow interior 11. The hollow interior 11 is sized and configured to permit the threaded adapter 3 to be moved longitudinally through the hollow interior 11. Attached to the cam portion 10 is an alignment mechanism, such as a locating pin 12. The locating pin 12, which may be broken free when not required, helps the correct positioning and/or alignment (rotationally) of the cam portion 10 during fitting. More specifically, the locating pin 12 is adapted to cooperatively interact with an alignment device, such as receiving apertures 214 disposed in the surface 13 and the plumbing connection 1.

The cam portion 10 is affixed to the surface 13, which may represent a floor structure, lip or mounting point on a shower tray, bath tub surround, or a variety of other anchoring surfaces. Mechanical fasteners 14 are used to fasten the cam portion 10 to the surface 13 and/or the plumbing connection 1. An adhesive sealant may additionally be used around the base of the cam portion 10 as normal trade practice dictates.

The cam portion 10 is disc-like in appearance. The cam portion 10 includes outwardly extending protrusions or flange portions 15 disposed at the top of the cam portion 10. Preferably they are outwardly extending flange portions 15 which interact with similar protrusions or flanges 23 on the engaging portion 20.

This detailed description will now focus upon the engaging portion 20. The engaging portion 20 is shown already attached to the building element 30. The building element 30 may have cross-sections which may vary according to user choice, a few suitable examples of cross-sections within the spirit and scope of the present invention include “O”, oval, “D”, “C”, “U”, and “V”, as well as cross-sections which varying along the height of the building element 30. In the illustrated embodiment, a circular cross-section profile is described and illustrated for simplicity.

Bolts or other mechanical fasteners 21 are used to secure the engaging portion 20 to the building element 30. In the illustrated embodiment, the mechanical fasteners 21 engage a pair of u-shaped screw pipes 31 disposed on the inside wall of the building element. Raised portions, such as locating tabs 32 may be provided to help position and locate the building element 30 with regard to the engaging portion 20. Preferably, the locating tabs 32 are located such that the locating tabs are disposed within the central cavity 212 of the building element 30 when the building element 30 is attached to the surface 13, such that the locating tabs 32 are hidden from view. It should also be noted that although in the illustrated embodiment the engaging portion 20 is sized and configured such that the engaging portion is sandwiched between the building element 30 and the surface 13 and visible after installation, it should be apparent to those skilled in the art that connection assembly 202 may be modified slightly so that once connected, the engaging portion 20 is recessed entirely (and hence fully hidden) within the building element 30 and/or the surface 13.

The engaging portion 20 of the illustrated embodiment is annular in shape and includes a passageway, open center portion, or central aperture 22 to permit the plumbing 204 and 206, and/or other services, such as electrical services, to pass therethrough. Extending radially inward into the central aperture 22 are flange portions 23 which are sized and configured to cooperatively interact with the flange portions 15 associated with the cam portion 10, thereby interlocking the cam and engaging portions 10 and 20 to one another.

In light of the above discussion of the structure of the shower assembly 200, the installation of the shower assembly 200 will now be described. First, the plumbing fitting 1 is coupled to the cam portion 10 via fasteners 14, thereby sandwiching the surface 13 between a flange of the plumbing fitting 1 and the cam portion 10. The alignment pin 12 is disposed within the alignment apertures 214, thereby ensuring that the cam portion 10 is correctly aligned relative to the surface 13 and/or the plumbing fitting 1. A seal 36 may be disposed in a recess 232 in the engaging portion 20 so as to aid in impeding contaminants, such as water and debris, from entering the shower assembly 200. The threaded adapter 3 is screwed into the threaded female portion 4 of the plumbing fitting 1.

The next step in the method of installation is to couple the engaging portion 20 to the end of the building element 30 via fasteners 21. Then the connector 6 is withdrawn from the building element 30 and coupled to the complementary shaped end piece 5 of the threaded adapter 3. The building element 30, with its associated plumbing 204 and engaging portion 20, may then be lowered downwardly over the cam portion 10. The building element should be positioned (i.e., rotated) so that the flanges 23 of the engaging portion 20 do not interfere with the flanges 15 of the cam portion 10 as the assembly is being lowered upon the cam portion 10. Moreover, the flanges 23 of the engaging portion 20 should be aligned with clearance cuts (i.e. the open spaces 250 (see FIG. 8) in the cam portion 10 permitting the flanges 23 of the engaging portion 20 to pass between the flanges 15 of the cam portions 10) such that the flanges 15 and 23 may be linearly moved past each other.

Once lowered, the building element 30 is rotated so that the flanges 23 of the engaging portion 20 engage the flanges 15 of the cam portion 10 in an overlapping relationship, interlocking the cam portion 10 with the engaging portion 20 as shown in FIG. 2. This arrangement impedes the building element 30 from being removed from the cam portion 10, while permitting the passage of the plumbing 204 and 206 between the surface 13 and the building element 30. The arrangement results in the coupling of the building element 30 securely to the surface 13 with no externally visible evidence of attachment and of the plumbing 204 and 206 running therethrough.

It can be appreciated the method of attachment is very simple once the cam portion 10 has been fastened to surface 13, and engaging portion 20 has been fastened to the building element 30. It is envisaged that the coupling of the engaging portion 20 to the building element 30, and the cam portion 10 to the surface 13 will preferably be completed at an earlier stage by the various trades persons, or during the manufacturing and assembly process of the shower assembly 200 for pre-plumbed embodiments. When the plumber or resident is ready to finally erect the building element 30, all that is required is the simple coupling of the connector 6 to the threaded adapter 5, and a bayonet type fitting action of the building element 30 to the cam portion 10. This arrangement makes installation substantially easier in the instance where not all trade persons are present on site at the same time. The use of fitting templates for the accurate positioning of the cam portions 10 can also facilitate the ease of installation for trade persons present at earlier stages, and ensure a more accurate subsequent fitting of components during final erection of a shower enclosure, partitioning, etc.

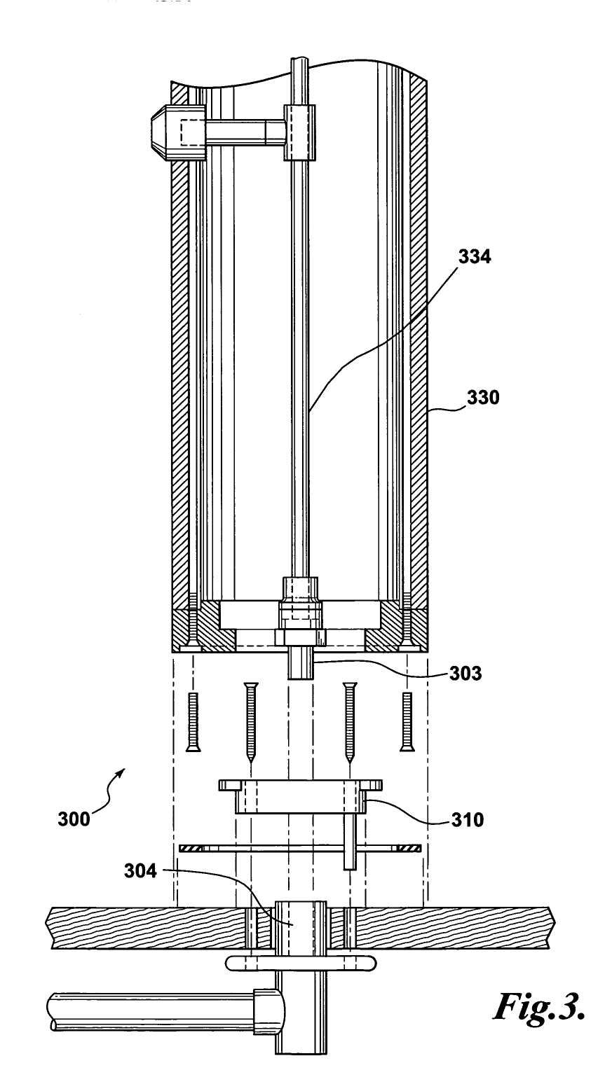

FIG. 3 illustrates an alternate embodiment of a connection assembly 300 formed in accordance with the present invention. The connection assembly 300 of FIG. 3 is substantially similar in operation and construction to the connection assembly 202 depicted in FIGS. 1 and 2, with a couple of exceptions. Therefore, for the sake of brevity, this detailed description will focus on the features which deviate from the previously described embodiment.

Generally stated, the connection assembly 300 of FIG. 3 differs from the embodiment of FIGS. 1 and 2 in that the flexible section 34 of pipe of FIGS. 1 and 2 has been replaced with a rigid section 334 of pipe. Further, the threaded adapter 3 of FIGS. 1 and 2 has been replaced with a quick connect or push connect fitting 303. Likewise, the threaded female portion 4 of FIGS. 1 and 2 has been replaced with a quick connect or push connect fitting 304 selected to cooperatively couple in fluid communication with fitting 303 in a quick connect manner.

In operation, the connection assembly 300 is configured such that it is possible that adequate connection of plumbing sections can be completed by merely pushing the building element 330 over the cam portion 310 in order to complete the bayonet fastening arrangement. In contrast to the embodiment of FIGS. 1 and 2, in the embodiment of FIG. 3, it will not be necessary to pull the internal plumbing section free of the end of the building element 330. Since it is generally desirable that some visual confirmation of a secure connection be made, it is envisioned that this connection assembly 300 would be preferably used in situations where visible inspection and/or adjustment can be made through the wall of the building element itself.

Although a rigid and straight piece of pipe is used to form the rigid section 334 of pipe in the illustrated embodiment, it should be apparent to those skilled in the art that other forms of the rigid section 334 are within the spirit and scope of the present invention. For instance, copper tubing formed in a helical manner as depicted in FIGS. 1 and 2 may be used, such that the helical shape of the rigid section 334 acts as a stiff spring, slightly biasing the push connect fitting 303 towards the corresponding push connect fitting 304 to aid in the coupling of the fittings 303 and 304 to one another while allowing for some tolerance to handle some miss-alignment of the fittings 303 and 304.

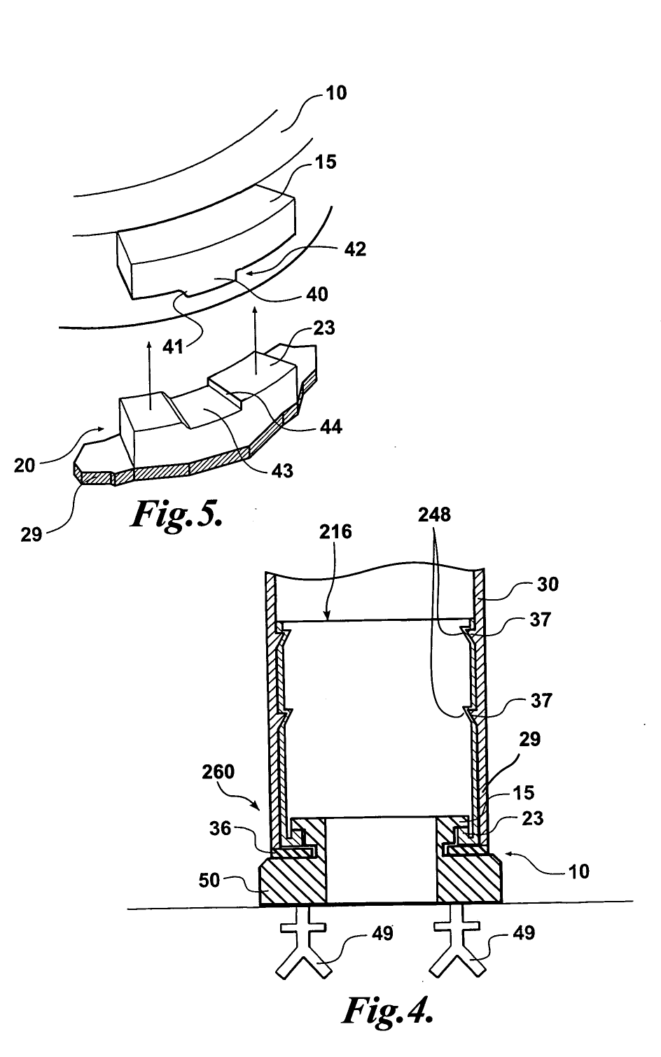

Referring to FIG. 4, an alternate embodiment of a connector assembly 260 formed in accordance with the present is provided. The connector assembly 260 includes an engaging portion insert 216 which can be positioned and held within the building element 30. The building element 30 shown in FIG. 4 includes barbs 37 disposed on an interior wall of the building element 30 which interact with cooperatively shaped recesses 248 disposed in the engaging portion insert 216 to help maintain the insert in place. A plurality of such interacting features may be used to help retain the engaging portion insert 216 in position. Other fixing and fastening methods may also be considered and are within the spirit and scope of the present invention.

In FIG. 4, the cam portion 10 also includes a base 50 which helps tidy the end of the building element 30. The base 50 rests on the surface into which the cam portion 10 is cast. Downwardly extending anchors 49 are embedded into the floor to secure the base 50 in place when the floor is cast. A washer type seal 36 may be used to provide a seal between the base 50 and the building element 30.

FIG. 5 is a detail view of a flange 15 of the cam portion 10 interacting with a flange 23 of the engaging portion 20 of the embodiment depicted in FIG. 4. Of note, the inwardly directed flange 23 is provided on an interior wall 29 of the engaging portion insert 216 as best shown in FIG. 4. These interacting flanges 15 and 23 are suitable for use with the embodiments described in FIGS. 1-3. Visible on each flange 15 of the cam portion 10 is a downwardly directed projection 40. Assuming for illustrative purposes, rotation of the building element (and thus the engaging portion 20) in a clockwise direction for fitting and securing of the building elements upon the cam portion 10, the leading edge 41 of the flange 15 may be inclined while the trailing edge 42 is substantially perpendicular to the bottom face of the flange 15. As can be appreciated, this ratchet type design will resist anti-clockwise turning should projection 40 extend into a recess 43 such as is shown on the flange 23 of the engaging portion 20. Similarly, one face 44 of the recess 43 is substantially vertical to resist anti-clockwise turning once the projection 40 is present within the recess 43. This provides a rotation resisting function resisting subsequent rotation and removal of the attached building element 30 and its associated components. As should be apparent to those skilled in the art, the leading and trailing angles can be varied to suit the requirements of the user. For instance, the height and angle of the leading and trailing angles can be varied such that once the cam portion 10 is interlocked with the engaging portion 20, the cam portion 10 is in a fully locked arrangement with the engaging portion 20, such that cam portion 10 is substantially permanently coupled to the engaging portion 20.

Even where a rotation resisting provision is not made, the provision of interacting features (such as projection 40 and recess 43) may be desirable to help ensure the correct degree of rotation during assembly. Other methods including stops and raised end projections (on the flange portions and elsewhere within the various components) may also be considered to achieve the same effect so as to ensure that connected components end up in the correct rotational position.

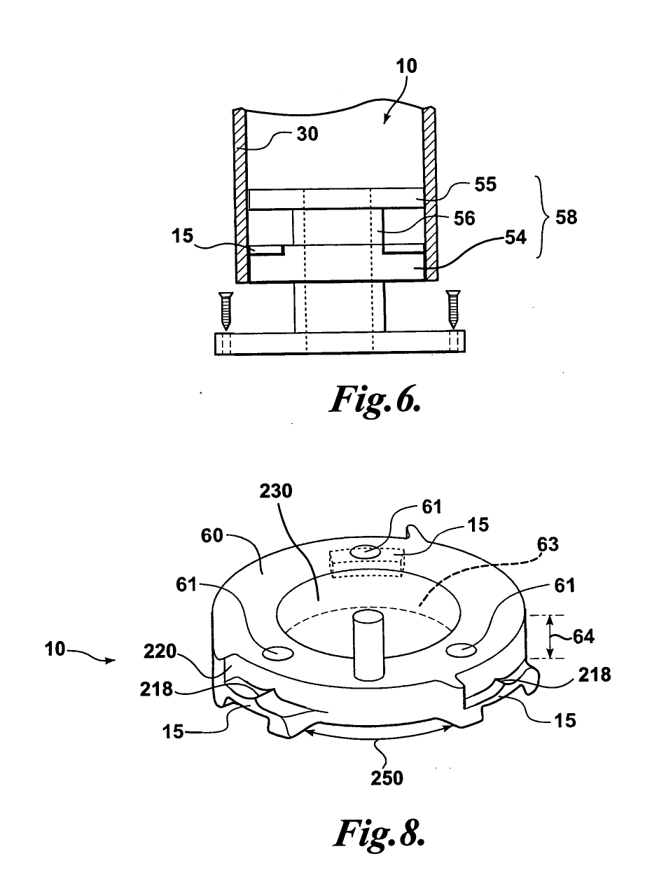

FIG. 6 illustrates another embodiment of the cam portion 10 formed in accordance with the present invention. The cam portion 10 of FIG. 6 includes multiple disc-like portions for further impeding the building element 30 from pivoting with respect to the cam portion 10. This embodiment is used in situations where a stronger or more rigid coupling of the building element 30 to the surface is desired. In the illustrated embodiment, in addition to the disc-like portion 54 of the cam portion 10, an additional disc-like portion 55 is provided. This upper disc-like portion 55 may include outwardly extending flanges (not shown) which also interact with inwardly directed flange portions on the building element 30 or its insert. In the embodiment of FIG. 6, no such features are provided, with the outer periphery of the upper annular disc-like portion 55 configured to bear against the inside wall of the building element 30. Removed portions extending inwardly from the periphery (not visible in the diagram) should be provided to permit the flange portions on the engaging portion to travel past.

Still referring to FIG. 6, the building element 30, which has not been completely lowered into place, is depicted to illustrate how the outer periphery of portion 55 bears against the inside of the building element 30. It can be appreciated that the two points of contact further stabilizes the arrangement and helps prevent pivoting of the building element 30 with respect to the cam portion 10.

As a variation, the upper disc-like portion 55 and a separating body portion 56 may be removable/attachable to lower disk-like portion 54. This may be by means of a threaded or other arrangement. It is further possible that additional elements 58 (disc-like portion 55 and/or separating body portion 56) may be stacked sequentially one upon the other to extend the height of the cam portion 10 and thus alter its relationship with the building element 30.

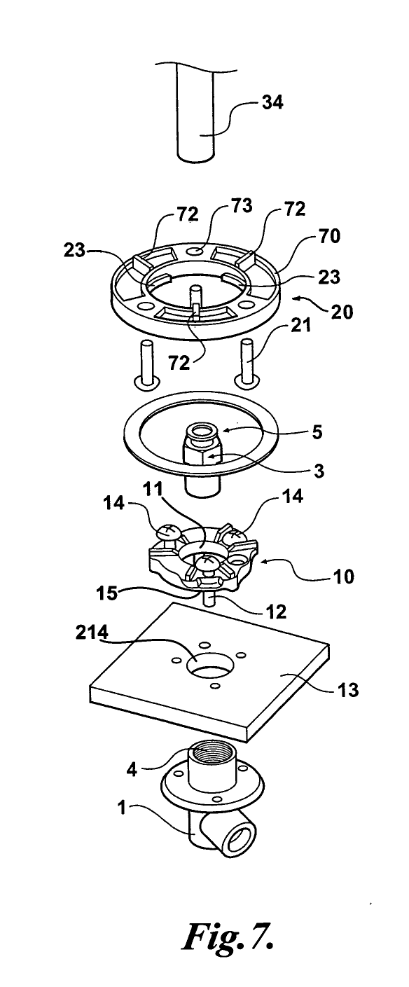

FIG. 7 illustrates one embodiment of an engaging portion 20 formed in accordance with the present invention and suitable for use with the embodiments of FIGS. 1-3. As can be seen, the primary body 70 of the engaging portion is substantially annular in appearance. Three inwardly extending flange portions 23 are present and again positioned to correspond with the position of the flanges 15 associated with the cam portion 10.

Centering tabs 72 are disposed on the upper face of body 70 to correctly position the wall of the building element 30 (see FIG. 1). Apertures 73 are provided for fasteners 21 to pass through and secure the annular engaging portion 20 to the building element. Open hollow tubular features of substantially “C”, “U”, or “V” (other shapes can be considered) cross section are provided on the interior of the building element into which the fasteners 21 may be screwed.

The various components associated with the present invention may be constructed from different materials. Metals may be used, though metals that are preferably corrosion resistance are preferred. Materials such as aluminum and its alloys, various stainless steels, bronzes and brasses, etc., may all be employed. They may be fabricated by casting, machining, combinations of both, and/or by other suitable manufacturing processes. Such materials may be utilized for the cam portion and associated components, the engaging portion and associated components, as well as the building element.

Other materials may also be considered. Plastic materials are especially suitable and again, many are known which are suitable for casting, machining, and for various other fabrication techniques. High impact thermoplastic materials may be considered for use. Materials worthy of consideration include many nylons, polyurethanes, as well as composite materials, and resin based materials.

Seals and washers, if provided, may be manufactured from normally utilized materials for these types of components. Sealant materials (e.g., caulks, etc.) may also be used.

The building element may be substantially constructed of one or more components, with the same choice of materials as the cam and the engaging portions described above. However, other materials may also be considered, as well as different fabrication techniques. Where the building element is of substantially constant cross section, extruded lengths and sections may be considered. In the preferred embodiment of FIG. 1, the building element is an extruded section of aluminum, though it may be formed from an alternative material, such as discussed above.

FIG. 8 illustrates a bottom perspective view of the cam portion 10 depicted in FIG. 7. FIG. 8 illustrates the annular shaped main body 60 of the cam portion 10 and the outwardly extending flanges 15 of the cam portion 10. The flanges 15 each include a distension, tooth or protrusion 218 which engages a cooperatively shaped detent or recess disposed in each of the flanges of the engaging portion to impede rotation of the engaging portion relative to the cam portion 10 in the unlocking direction. A limit stop 220 associated with each flange 15 impedes additional rotation in the locking direction of the engaging portion relative to the cam portion 10 once the two portions are in the engaged/locked position. Apertures 61 allow for fastening screws or bolts to pass therethrough.

In FIG. 8, the central portion 63 has a removable plate 230 which may be punched or knocked out should it be necessary to pass services therethrough. As can also be seen, the flanges 15 are distanced from the main body 60 of the cam portion 10 by a selected distance 64. This allows for the flange portions of the engaging portion to be positioned underneath, and also to compensate for the thickness of any seals which are used during installation.

Three outwardly extending flange portions 15 are shown, though other quantities are suitable for use with and within the spirit and scope of the present invention, including quantities greater or less than three. While these may be spaced equidistantly about the periphery, non-equidistant spacing may be preferable to ensure that the attached member can only be positioned and attached in a single angular orientation. This will help prevent building elements being fitted in incorrect orientations, a particular problem where hinges, jets or supports are provided on the building element.

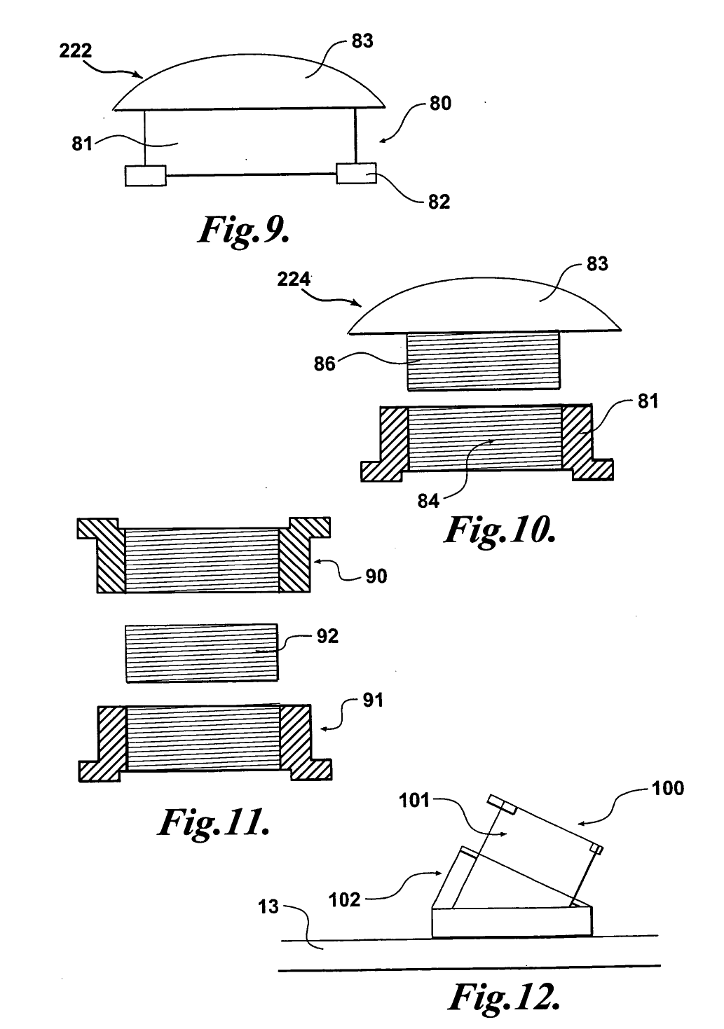

FIG. 9 illustrates one embodiment of a capping member 222 formed in accordance with the present invention. The capping member 222 is a further variation of the previously described cam portions. Some building elements formed in accordance with the present invention will have a top or alternate end which may be open. If this is to be capped, it may be desirable to accomplish this without visible connection means. FIG. 9 illustrates one embodiment of a capping member 222 which may be used to cap the opening. The capping member 222, in its simplest form, represents substantially a cam portion such as illustrated in FIG. 1 (as item 10) though without locating pin 12. Fastening apertures 61 (see FIG. 8) may not be present either. Flange portions 82 (corresponding to flanges 15 in FIG. 1) are also provided on the main body 81 of the capping member 222. An aesthetically pleasing and appropriate cover piece 83 is provided on the ultimate end of the body 81, which would normally be the end which would contact the floor or surface 13 in FIG. 1.

The building element (not shown for simplicity in FIG. 9) would also be modified to include an engaging portion with which the capping member 222 can interact. Accordingly, substantially the same component may, with minimal (or no) modification, be used for fixing the building element to a surface, as well as for capping/closing an open end of the building element.

An alternate embodiment of a capping member 224 formed in accordance with the present invention is shown in FIG. 10. The alternate embodiment depicted in FIG. 10 is substantially identical to the embodiment depicted in FIG. 9, with the exception that the cover piece 83 is separable from the primary body 81 of the capping member 224. In this arrangement, an internal aperture 84 of the capping member 224 is threaded to allow the cap 83 to be screwed in by virtue of its projecting stem piece 86. In this arrangement, the primary body 81 may also serve as a capping portion and therefore can be used at either or both ends of the building element. As a further variation, the internal aperture 84 of the primary body 81 need not be threaded, but instead, the downwardly directed stem portion 86 can be configured to allow an interference fit, or another type of connection to maintain the cover piece 83 in place.

FIG. 11 illustrates an arrangement utilizing the internally threaded cam portion 81 of FIG. 10. If two of these threaded cam portions 90 and 91 are connected by a threaded tube or rod 92, the result is a connector enabling two sections of building element to be quickly connected to one another. This increases the versatility of the cam portion and allows it to be used in a number of manners.

FIG. 12 illustrates an embodiment of the cam fixture 100 which may be used for connecting building elements at an angle to the surface 13. Here the main hollow body portion 101 is inclined at an angle to the main base portion 102, which is also configured to seat the base of the building element. These embodiments may be available in a variety of angles to suit different types of construction of enclosures, which will compensate for surfaces at different angles from the perpendicular or horizontal. Some angles (measured with respect to the surface) may be relatively shallow (e.g., 1.5 to 5 degrees) and thus these fixtures may compensate for natural inclines in the surface for water drainage. In other instances they may be configured to follow the contour of an irregular or non-planar surface mounting position. This is likely to be where the cam portion is not fixed to a wall or floor, but to a tray, tub, or installed article.

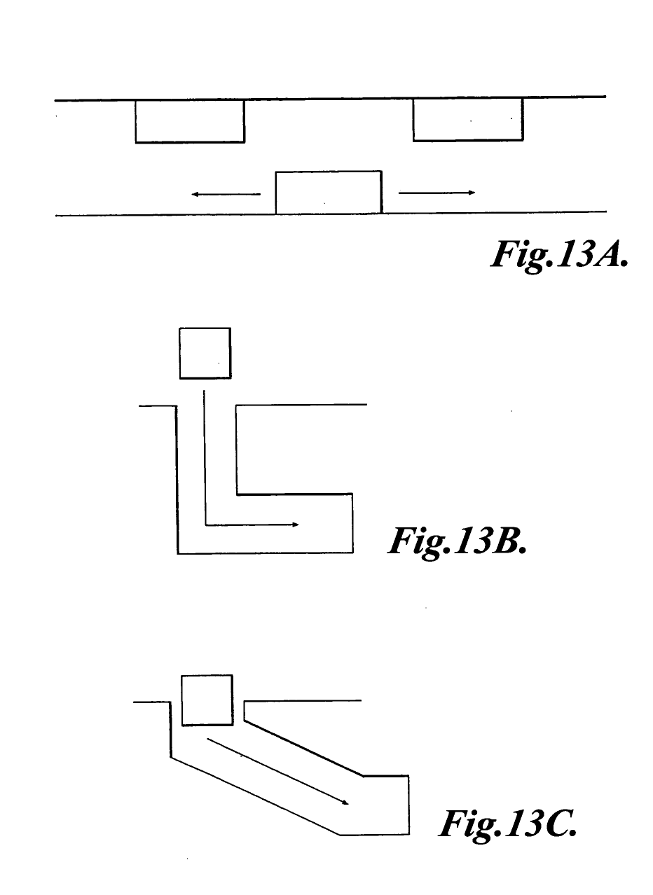

FIG. 13 illustrates, in a conceptual schematic form, the preferred types of bayonet action discussed earlier. FIG. 13A illustrates the ‘flat bayonet action’ where overlapping components of the engaging components only start to overlap with each other when rotation occurs after linear positioning. FIG. 13B represents the typical ‘light bulb type’ bayonet action where a guide element substantially prevents or limits relative rotation until linear positioning is completed. FIG. 13C represents a ‘helical bayonet action’ in which rotation introduces a linear component to the relative movement of the engaging portions—such as drawing one portion down into the other.

While the preferred embodiments of the invention have been illustrated and described, it will be appreciated that various changes can be made therein without departing from the spirit and scope of the invention.

1. A quick connect assembly for connecting a building element to a surface, the quick connect assembly comprising:
(a) a first locking member coupled to one of a building element or a surface, the first locking member having a first passageway extending through the first locking member; and
(b) a second locking member coupled to the other of the building element or the surface, the second locking member having a second passageway extending through the second locking member, the first and second locking members having co-operative cam locking elements to reversibly couple the building element to the surface.

2. The quick connect assembly of claim 1, wherein the first and second locking members are adapted to reversibly couple to one another through a bayonet type action.

3. The quick connect assembly of claim 1, wherein when the first and second locking members are reversibly coupled to one another, the first and second passageways are substantially aligned with one another to permit services to pass between the surface and the building element through the first and second passageways.

4. The quick connect assembly of claim 1, wherein the first locking member includes a recess for receiving a seal for substantially sealing the first locking member to either the surface or the building element.

5. The quick connect assembly of claim 1, wherein the first locking member has an annular shaped body disposed about the first passageway.

6. The quick connect assembly of claim 5, wherein the co-operative cam locking elements include a protrusion extending from the annular shaped body and a cooperatively shaped structure disposed on the second locking member, and wherein the protrusion and the cooperatively shaped structure are engageable with one another to reversibly couple the first and second locking members to one another.

7. The quick connect assembly of claim 5, wherein the second locking member is sized and configured so that at least a portion of the second locking member may be positioned within the first passageway of the first locking member.

8. The quick connect assembly of claim 7, wherein the co-operative cam locking elements include a protrusion disposed on the second locking member and a cooperatively shaped structure disposed on the first locking member such that when the portion of the second locking member is received within the first passageway and the locking members are reversibly coupled to one another, the cooperatively shaped structure of the first locking member overlaps the protrusion of the second locking member.

9. The quick connect assembly of claim 1, wherein one of the locking members includes a distension and the other of the locking members includes a detent for receiving the distension when the locking members are reversibly coupled to one another to provide a selected amount of rotational resistance to impede relative rotation of the locking members.

10. The quick connect assembly of claim 1, wherein one of the locking members includes an alignment mechanism, wherein the alignment mechanism interfaces with a cooperatively shaped alignment device disposed on either the building element or the surface such that the locking member having the alignment mechanism is adapted to be coupled in a selected orientation relative to the building element or the surface having the alignment device.

11. The quick connect assembly of claim 1, wherein the locking members are rotated less than 360 degrees during the reversible coupling of the locking members.

12. The quick connect assembly of claim 1, wherein the co-operative cam locking elements include a cam disposed on each of the first and second locking members, and wherein the cams engage one another when the locking members are reversibly coupled to one another such that the cam of the first locking member is sandwiched between the cam of the second locking member and the building element or the surface.

13. The quick connect assembly of claim 1, further including plumbing for transferring fluids between the surface and the building element, the plumbing extending from below the surface to within the building element and passing through the first and second passageways, wherein the plumbing includes a first fitting adapted to couple in fluid communication to a second fitting.

14. The quick connect assembly of claim 13, wherein the first fitting is coupled to the plumbing disposed below the surface and the second fitting is coupled to the plumbing disposed within the building element.

15. The quick connect assembly of claim 14, wherein the first fitting is stationary relative to the second locking member and the second fitting is movable relative to the first fitting such that the second fitting may be longitudinally displaced from the first fitting.

16. The quick connect assembly of claim 15, wherein the second fitting is coupled to an extendable section of the plumbing, wherein a stationary end of the extendable section is stationary relative to the building element and a movable end of the extendable section of the plumbing is coupled to the second fitting such that the second fitting may be selectively displaced from the stationary end of the extendable section.

17. The quick connect assembly of claim 16, wherein the first fitting is coupled to the second locking member.

18. The quick connect assembly of claim 1, wherein the second locking member includes a limit stop, wherein the limit stop is located to engage the first locking member when the first and second locking members are reversibly coupled to one another to impede further rotation of the first and second locking members relative to one another in a selected direction.

19. The quick connect assembly of claim 1, wherein the first and second passageways and at least one of the locking members are hidden from view from a user viewing an exterior surface of the building element when the locking members are reversibly coupled to one another.

20. A quick connect assembly for connecting a building element to a surface while permitting services to pass between the surface and the building element through the quick connect assembly, the quick connect assembly comprising:
(a) an interference member coupled to the building element or the surface, the interference member having a protrusion; and
(b) a receiving member coupled to the other of the building element or the surface, the receiving member having an engagement member, wherein the interference member may be positioned in a first position such that the protrusion may be longitudinally moved past at least a portion of the receiving member, and a locked position in which the interference member has been rotated a predetermined angular displacement from the first position such that the protrusion engages the engagement member to interlock the building element to the surface.

21. The quick connect assembly of claim 20, wherein the interference member includes a recess for receiving a seal for substantially sealing the interference member to either the surface or the building element.

22. The quick connect assembly of claim 20, wherein the interference member has an annular shaped body forming an open inner portion for permitting a conduit to pass therethrough.

23. The quick connect assembly of claim 22, wherein the protrusion extends inward from the annular shaped body into the open inner portion.

24. The quick connect assembly of claim 22, wherein the receiving member may be at least partially positioned within the open inner portion.

25. The quick connect assembly of claim 24, wherein the engagement member extends outward from the receiving member such that when the receiving member is at least partially received within the open inner portion of the interference member and the interference member is in the locked position, the protrusion and engagement member overlap one another.

26. The quick connect assembly of claim 20, wherein either the engagement member or the protrusion include a distension and the other of the engagement member or the protrusion includes a detent for receiving the distension when the interference member is in the locked position to provide a selected amount of rotational resistance impeding the rotation of the interference and engagement members relative to one another.

27. The quick connect assembly of claim 20, wherein the interference member or the receiving member includes an alignment mechanism, wherein the alignment mechanism interfaces with a cooperatively shaped alignment device disposed on either the building element or the surface such that the interference member or receiving member is oriented in a selected orientation relative to the building element or surface.

28. The quick connect assembly of claim 20, wherein the predetermined angular displacement is less than 360 degrees.

29. The quick connect assembly of claim 20, wherein the receiving member includes a passageway for permitting services to pass through the receiving member.

30. The quick connect assembly of claim 20, wherein when the interference member is in the locked position, the protrusion is sandwiched between the engagement member and the building element or the surface.

31. The quick connect assembly of claim 20, wherein the receiving member is transitioned between the first position and the locked position by a bayonet type action.

32. A connection assembly for connecting a building element to a surface and providing for services to pass between the surface and the building element, the connection assembly comprising:
(a) a building element having a cavity;
(b) a surface for supporting the building element;
(c) a quick connect assembly for coupling the building element to the surface, the quick connect assembly having a passageway passing through the quick connect assembly; and
(d) a conduit for transferring services between a location disposed below the surface and the building element, the conduit passing through the cavity and the passageway.

33. The connection assembly of claim 32, wherein the quick connect assembly includes:
(a) an interference member coupled to the building element or the surface, the interference member having a protrusion; and
(b) a receiving member coupled to the other of the building element or the surface, the receiving member having an engagement member, wherein the interference member may be positioned in a first position such that the protrusion may be longitudinally moved past at least a portion of the receiving member, and a locked position in which the interference member has been rotated a predetermined angular displacement from the first position such that the protrusion engages the engagement member to reversibly interlock the building element to the surface.

34. The connection assembly of claim 32, wherein the conduit includes an adjustable section adjustable in length associated with either the building element or the surface and a second section associated with the other of the building element or the surface.

35. The connection assembly of claim 34, wherein the second section remains substantially immobile relative to the building element or the surface it is associated with.

36. The connection assembly of claim 34, further including a coupling assembly having a first coupling member coupled to the adjustable section and a second coupling member coupled to the second section wherein the first and second coupling members are adapted to be coupled to one another to place the adjustable section in fluid communication with the second section.

37. The connection assembly of claim 36, wherein the first coupling member is rigidly coupled to either the building element or the surface as to remain substantially stationary relative to the building element or the surface to which it is coupled to, and wherein the second coupling member is coupled to the other of the building element or the surface such that the second coupling member is free to rotate and to be longitudinally displaced with respect to the building element or the surface of which it is associated with.

38. The connection assembly of claim 36, wherein the adjustable section is adjustable in length such that the first coupling member is positionable between an extended position in which at least a majority of the first coupling member is disposed outward of the building element or surface and a retracted position in which at least a majority of the first coupling member is spaced inward of the building element or surface, wherein the first coupling member is adapted to be placed in the extended position and coupled to the second coupling member while the building element is detached from the surface and wherein the first coupling member is adapted to be placed in the retracted position when the building element is coupled to the surface.

39. The connection assembly of claim 38, further comprising a control device coupled to the building element and in communication with the adjustable section of the conduit, the control device adapted to regulate passage of services through the conduit, wherein the control device is coupled to the adjustable section prior to coupling of the building element with the surface, wherein the adjustable section may be manipulated to adjust a separation distance of the first coupling member from the control device to permit the first coupling member to be placed in the extended and retracted positions.

40. The connection assembly of claim 33, wherein the predetermined angular displacement is 360 degrees or less.

41. The connection assembly of claim 33, wherein the building element may be rotated without the use of tools the predetermined angular displacement.

42. The connection assembly of claim 33, wherein when the building element and the surface are coupled to one another, the conduit and the receiving member are substantially hidden from view.

43. The connection assembly of claim 33, wherein the receiving member includes a top surface having a clearance cut disposed therein for permitting the protrusion to pass longitudinally downward past the top surface, and wherein once the interference member has been rotated to the locked position, the top surface is disposed over the protrusion to impede longitudinal movement of the interference member relative to the receiving member in at least one direction.

44. The connection assembly of claim 43, wherein the interference member includes an annular body having an open center portion, wherein the one protrusion extends inward into the open center.

45. The connection assembly of claim 44, wherein the receiving member is adapted to be at least partially received and rotated within the open center portion of the interference member.

46. The connection assembly of claim 33, further including an alignment member coupled to either the interference or receiving member, wherein the alignment member is adapted to cooperatively interact with a cooperatively formed alignment member disposed on the surface or the building element, wherein the alignment members are configured to cooperatively interact with one another only when the interference or receiving member having the alignment member is oriented at a selected angular displacement relative to the surface or building element having the cooperatively formed alignment member such that when the building element is coupled to the surface, the building element is oriented in a selected orientation relative to the surface.

47. A connection assembly for connecting a building element to a surface and providing for services to be transferred between the building element and the surface, the connection assembly comprising:
(a) a cam engaging portion and a complementary engaging portion which interact with each other in a quick connect manner from an unlocked connection to a locked connection;
(b) one of the engaging portions being coupled to the surface, and the other engaging portion positioned at an end of the building element to be attached to the surface; and
(c) the engaging portions being configured to allow for services to pass therethrough.

48. The connection assembly of claim 47, wherein when the building element is attached to the surface, the services and the cam engaging portion are substantially hidden from view.

49. The connection assembly of claim 47, wherein the engaging portions interact with one another in a bayonet type action.

50. The connection assembly of claim 47, wherein the building element is an internally pre-plumbed pillar for use in a shower or bath enclosure which is modified for attachment to a substantially finished surface.

51. An internally pre-plumbed pillar for coupling to a surface and passing service therebetween via a service conduit, the internally pre-plumbed pillar comprising:
(a) a body with a hollow interior for housing at least a portion of the service conduit, the body including at or near one end a terminated section of plumbing comprising an extendible length of pipe biased to retract within the body; and
(b) an engaging portion disposed at or near the one end of the body, the engaging portion complementary to a separate engaging portion fixable to the surface, wherein the engaging portions interact to securely connect the pillar to the surface, wherein both engaging portions include open sections allowing the service conduit to pass therethrough.

52. A connection assembly for use in attachment of a building element to a structure, the connection assembly allowing for passage of plumbing associated with the building element through the connection assembly, the connection assembly comprising;
(a) a cam portion able to be fixed to the structure to which the building element is to be attached; and
(b) a complementary portion which engages with the cam portion so as to restrict longitudinal separation of one from the other, wherein the complementary portion is either formed into the building element or is fixable thereto, and wherein the complementary portion and the cam portion each contain an aperture for allowing passage of the plumbing associated with the building element therethrough.

53. The connection assembly of claim 52, wherein the cam portion includes a plumbing connection for the connection of the plumbing associated with the building element thereto.

54. The connection assembly of claim 52, further comprising limit stops for restricting rotation of the cam portion relative to the annular portion past a selected angle.

55. The connection assembly of claim 52, further including complementary quick connect plumbing connections provided on the cam portion and the plumbing associated with the building element.

56. A building element for use in a connection assembly, wherein the building element comprises:
(a) a hollow section disposed along at least part of a length of the building element; and
(b) an extendible plumbing extension portion further including:
(i) a movable section of pipe which can be extended from a retracted position wherein a distal end of the movable section of pipe is substantially within the hollow section of the building element to an extended position wherein the distal end is substantially outside of the hollow section of the building element; and
(ii) a plumbing connection coupled to the distal end, the plumbing connection adapted to allow connection of the plumbing connection to a complementary plumbing connection.

57. The building element of claim 56, wherein the extendible plumbing extension portion comprises a retractable section of pipe which is biased to retract within the hollow section.

58. The building element of claim 56, wherein the plumbing connection is rotatable relative to the movable section of pipe.

59. The building element of claim 56, wherein the extendible plumbing extension portion comprises a flexible coil of pipe.

60. The building element of claim 56, further including one or more nozzles coupled in fluid communication with the extendable plumbing extension portion for discharging a fluid from the building element.

61. The building element of claim 60, wherein the one or more nozzles are pre-plumbed to the building element so as to be in fluid communication with the extendable plumbing extension portion.

62. The building element of claim 60, further including an engagement portion coupled to the building element, the engagement portion adapted to couple to a cam portion disposed on a surface to interlock the building element to the surface.

63. The building element of claim 62, wherein the cam portion comprises a disc shaped portion, and wherein sections of the disc shaped portion are open to permit the engagement portion to move past the open sections.

64. The building element of claim 63, wherein the disc shaped portion of the cam portion is disposed above the surface to which the cam portion is attached.

65. The building element of claim 63, wherein the engagement portion includes raised elements to assist in aligning the building element relative to the engagement portion.

66. The building element of claim 63, wherein the cam portion includes a pipe connection attached to or integrated with the cam portion.

67. The building element of claim 63, wherein the cam portion includes rotation resisting means for interacting with features on the engagement portion to resist rotation of the engagement portion relative to the cam portion.

68. The building element of claim 67, wherein the resisting means comprises a resisting device selected from the group consisting of a ratchet type arrangement, a full locking arrangement, and a detent arrangement.

69. A method of coupling a building element to a surface comprising:
(a) coupling to an attachment end of the building element a first engaging portion;
(b) attaching on the surface a second engaging portion which is configured to engage the first engaging portion to reversibly couple the building element to the surface in a bayonet type manner; and
(c) installing a service conduit for passing a service between the building element from a point below the surface to a point within the building element, wherein the service conduit passes through the first and second engaging portions such that the service conduit is hidden from view when the building element is reversibly coupled to the surface.

70. The method of claim 69, wherein one of the engaging portions includes a cam portion and the other engaging portion includes a complementary portion.

71. The method of claim 70, wherein the cam portion comprises a disc portion having at least one engaging portion of which the complementary portion interacts.

72. The method of claim 70, wherein the cam portion includes a plumbing connection to which the service conduit may be connected.

73. The method of claim 70, wherein the cam portion includes an alignment provision for allowing the cam portion to be affixed to the surface or the building element in a selected orientation.

74. The method of claim 70, wherein the cam portion includes an aperture through which the service conduit may pass.

75. The method of claim 69, wherein the surface is selected from the group consisting of: a floor, a shower receptor, a bath tub, a partial wall structure, a wall, a surround, a horizontal support surface, an inclined support surface, and a vertical support surface.

76. The method of claim 69, wherein the building element, after being reversibly coupled to the surface, is in a substantially vertical position.

77. The method of claim 69, wherein the building element houses plumbing, and wherein the plumbing is modified such that at an end of the plumbing closest to the end of the building element being attached to the surface is movable so as to be able to be temporarily withdrawn from the end of the building element to allow attachment to a plumbing connection.

78. A method for attaching a building element forming part of a shower assembly to a support surface, said method including:
(a) fixing a first engaging portion and a plumbing connection to the support surface;
(b) connecting a complementary second engaging portion to one end of the building element;
(c) installing plumbing within the building element with an end portion moveable outward from the building element to allow for connection of the plumbing to the plumbing connection fixed to the surface;
(d) bringing the end of the building element into proximity with the first engaging portion and connecting the end portion of the plumbing to the plumbing connection; and
(e) coupling the first and second engaging portions to one another in a quick to connect manner to couple the building element to the surface.

79. The method of claim 78, wherein the first and second engaging portions engage one another in a bayonet type manner.

80. A method for attaching a building element of a shower assembly to a support surface, the building element housing plumbing, said method including:
(a) fixing a first engaging portion to the support surface;
(b) fixing a first plumbing connection to the support surface;
(c) attaching a complementary second engaging portion capable of interlocking with the first engaging portion on the building element;
(d) providing the plumbing within the building element with an end portion which is substantially rigid and fixing a second plumbing connection to the end portion;
(e) positioning the second engaging portion of the building element over the first engaging portion coupled to the support surface; and
(f) interlocking the first engaging portion with the second engaging portion, wherein the interlocking of the engaging portions also results in connection of the first and second plumbing connections to one another.

81. The method of claim 80, further including aligning a provision of the cam portion with a complimentary provision associated with the surface, wherein alignment of the provisions permits the building element to be oriented in a selected orientation relative to the surface when the building element is attached to the surface.

82. The method of claim 80, wherein the building element is substantially a hollow member.

83. The method of claim 80, wherein the interlocking of the engaging portions results in connection of the first and second plumbing connections to one another in a quick connect type arrangement.

84. The method of claim 80, wherein the building element is rotated less than 360 degrees when interlocking the first engaging portion with the second engaging portion.

85. A method of installing a shower enclosure which includes one or more building elements, wherein the building elements house plumbing associated with the enclosure, and wherein the building elements are coupled to a base structure, said method including:
(a) positioning and fixing to the base structure a cam portion for attaching the building element to the base structure;
(b) bringing an end of the building element into proximity to the cam portion and connecting the plumbing housed within the building element to a plumbing connection associated with the base structure, and
(c) affixing the building element to the cam portion by engagement of a complementary engaging portion present at the end of the building element with the cam portion.

86. The method of claim 85, wherein the base structure is substantially finished prior to the positioning and fixing of the cam portion upon the base structure.

87. The method of claim 85, wherein a floor of a building forms the base structure for the shower enclosure, the method further including positioning of a waste pipe and additional plumbing in the floor and terminating the waste pipe and the additional plumbing substantially flush with the floor.

88. The method of claim 87, wherein the additional plumbing is routed through the cam portion to be connected to the plumbing disposed within the building element.

89. The method of claim 85 in which the plumbing associated with the building element, the additional plumbing associated with the floor, and the cam portion are substantially hidden from view after the building element has been affixed to the cam portion.
